(19) United States
(12) Patent Application Publication
(10) Pub. No.: US 2024/0306840 A1
(43) Pub. Date: Sep. 19, 2024

(54) BEVERAGE BREWING DEVICES

(71) Applicant: SharkNinja Operating LLC, Needham, MA (US)

(72) Inventors: Joshua Cole DETTMAR, Essex (GB); James Alexander PARRY, Altrincham (GB); Steven Paul CARTER, London (GB); Ethan BROWN, Wayland, MA (US); Scott SHAW, Waltham, MA (US); David Conor DYKEMAN, Framingham, MA (US)

(21) Appl. No.: 18/311,013

(22) Filed: May 2, 2023

Related U.S. Application Data
(63) Continuation of application No. PCT/CN2023/081560, filed on Mar. 15, 2023.

(51) Int. Cl. A47J 31/10; A47J 31/44; A47J 31/46

(52) U.S. Cl. CPC A47J 31/10; A47J 31/4407; A47J 31/446; A47J 31/46

(57) ABSTRACT

A beverage system is provided. An adaptor assembly can be used with the beverage system and include a brew basket defining a cavity therein and having a fluid outlet. The assembly also includes a pod adapter and a filter adaptor receivable within the cavity in the brew basket. The pod adapter has at least one engagement feature arranged to be received within at least one corresponding slot in the brew basket. The filter adaptor includes a showerhead coupled to the filter body, the showerhead being arranged to receive fluid through an opening therein and to distribute fluid into the filter body. An internal storage cavity can be arranged within the housing of the beverage system for storing the adaptors. Additionally, a flow path cover can be positioned on the beverage system and configured to prevent unintentional water discharge from a brew chamber.

### CROSS-REFERENCE TO RELATED APPLICATIONS

This application is a Continuation application of International Application No. PCT/CN2023/081560, filed Mar. 15, 2023, and entitled “BEVERAGE BREWING DEVICES,” the contents of which are hereby incorporated by reference in their entirety.

### FIELD

Beverage brewing apparatus, and assemblies for use in beverage brewing apparatus, are provided.

### BACKGROUND

Various systems and methods for brewing a beverage, such as coffee or tea, are known. These systems typically include drip brewing systems in which hot water is brewed through coffee grounds and into a carafe, or French press systems in which coffee grounds and water are mixed in a container and a water permeable plunger is pressed into the container from above to trap the ground coffee at the bottom of the container. Existing beverage brewing systems are typically designed to receive only a single format of flavorant, such as loose coffee grinds, or alternatively, a prepackaged pod or cartridge of coffee grinds.

Accordingly, in the event that a user desires to have the flexibility to use both loose coffee grinds and prepackaged pods of coffee grinds, they have to resort to purchasing two or more separate brewing systems to accommodate their desire. This can be cost prohibitive, and can take up extra space in a kitchen or café environment. Further, the maintenance that comes with cleaning and maintaining multiple brewing systems can be time consuming and cumbersome.

### SUMMARY

Beverage brewing devices and lid clips for use therewith are provided. In one embodiment, the beverage system can include a housing having a brew chamber defining a cavity therein. The beverage system can also include an opening arranged in the housing and arranged to allow access to the brew chamber. The beverage system can also include a lid arranged to selectively cover the opening of the brew chamber, the lid having at least one engagement feature. The beverage system can also include a filter assembly selectively receivable within the cavity of the brew chamber. The filter assembly can include a lower portion defining a cavity therein arranged to receive a brewing ingredient, and an upper portion arranged over the cavity of the lower portion. The upper portion can include at least one corresponding engagement feature arranged to receive the at least one engagement feature of the lid therein.

In another embodiment, the lid can include a first engagement feature and a second engagement feature arranged opposite each other. In some embodiments, the at least one engagement feature of the lid can include a spring-loaded projection, and the at least one corresponding engagement feature of the filter assembly can include at least one detent. In some embodiments, the at least one engagement feature can be arranged within a recessed cavity of the lid.

In another embodiment, the upper portion can include a first corresponding engagement feature and a second corresponding engagement feature arranged opposite each other. In some embodiments, the upper portion can be arranged to be secured to the lid such that the upper portion is removed from the lower portion when the lid transitions from a closed position to an open position.

In another embodiment, the first portion of the filter assembly can be a brew basket arranged to allow fluid flow therethrough, and the second portion can be a showerhead. The showerhead can be arranged to receive fluid through an opening therein and to distribute fluid into the brew basket.

In another embodiment, the detent can be positioned on raised projection extending upward from a top surface of the upper portion.

In another embodiment, the lid can include a projection including a fluid outlet therein. In this embodiment, the projection is positioned between a first corresponding engagement feature and a second corresponding engagement feature arranged opposite each other.

In another embodiment, the upper portion of the filter assembly can include an indication marker arranged to indicate a position of the upper portion within the brew chamber.

A filter assembly for use in a beverage system is provided. In one embodiment, the filter assembly can include a brew basket defining a cavity therein and having a fluid outlet. The filter assembly can also include a showerhead arranged to be positioned over the cavity of the brew basket, the showerhead being arranged to receive fluid through an opening therein and to distribute fluid into the brew basket. The filter assembly can also include at least one projection extending upward from a top surface of the showerhead, and at least one engagement feature positioned on the at least one projection.

In another embodiment, the brew basket can include a first handle extending radially outward from the brew basket. In some embodiments, the showerhead can include a second handle arranged to be positioned adjacent to the first handle when the showerhead is positioned above the cavity of the brew basket.

In another embodiment, the showerhead can include a first engagement feature and a second engagement feature arranged opposite each other. In some embodiments, the showerhead can include an indication marker arranged to indicate a position of the showerhead within the brew basket.

Beverage brewing devices and showerheads for use therewith are provided. In one embodiment, the beverage device can include a housing having a brew chamber defining a cavity therein. The beverage device can also include an opening arranged in the housing and arranged to allow access to the brew chamber. The beverage device can also include a lid arranged to selectively cover the opening of the brew chamber, the lid having a recessed cavity and at least one engagement feature positioned therein. The beverage device can also include a filter assembly selectively receivable within the cavity of the brew chamber. The filter assembly can include a brew basket defining a cavity therein and having a fluid outlet. The filter assembly can also include a showerhead arranged to be positioned over the cavity of the brew basket, the showerhead being arranged to receive fluid through an opening therein and to distribute fluid into the brew basket. The filter assembly can also include at least one projection extending upward from a top surface of the showerhead, and at least one corresponding engagement feature positioned on the at least one projection.

In another embodiment, the lid includes a first engagement feature and a second engagement feature arranged opposite each other. In some embodiments, the at least one engagement feature of the lid comprises a spring-loaded projection, and the at least one corresponding engagement feature of the filter assembly comprises at least one detent.

In another embodiment, the showerhead includes a first corresponding engagement feature and a second corresponding engagement feature arranged opposite each other.

### BRIEF DESCRIPTION OF THE DRAWINGS

These and other features will be more readily understood from the following detailed description taken in conjunction with the accompanying drawings, in which:

FIG. 1A is a front perspective view of one embodiment of a beverage brewing apparatus with a lid in an open configuration;

FIG. 1B is a front perspective view of the beverage brewing apparatus of FIG. 1A with the lid in a closed configuration;

FIG. 2A is a front perspective view of another embodiment of a beverage brewing apparatus with a lid in an open configuration;

FIG. 2B is a front perspective view of the beverage brewing apparatus of FIG. 2A with the lid in a closed configuration;

FIG. 3 is a schematic view of a beverage brewing system for use with the beverage brewing apparatuses of FIGS. 1A, 1B, 2A, and 2B;

FIG. 4 is a partially exploded perspective view of the beverage brewing apparatus of FIG. 1A illustrating a brew basket and a filter adaptor in a nesting configuration;

FIG. 5 is a partially exploded perspective view of the beverage brewing apparatus of FIG. 1A illustrating a brew basket and a pod adaptor in a nesting configuration;

FIG. 6A is a front perspective view of the brew basket of FIG. 4;

FIG. 6B is a cross-sectional view of the brew basket of FIG. 6A, taken along line D-D of FIG. 6A;

FIG. 7A is a front perspective view of the filter adaptor of FIG. 4 with a showerhead in a closed configuration;

FIG. 7B is a front perspective view of the filter adaptor of FIG. 7A with a first showerhead in an open configuration;

FIG. 7C is a front perspective view of the filter adaptor of FIG. 7A with another embodiment of a showerhead connected to the filter adaptor in an open configuration;

FIG. 7D is a front perspective view of a top surface of the showerhead of FIG. 7C;

FIG. 8 is a cross-sectional view of the beverage brewing apparatus of FIG. 1A-1B taken along section A-A of FIG. 1B showing the filter adaptor in the brew chamber;

FIG. 9 is a front perspective view of the pod adaptor of FIG. 5;

FIG. 10 is a cross-sectional view of the beverage brewing apparatus of FIGS. 1A-1B taken along section B-B of FIG. 1B with the pod adaptor inserted into a brew chamber;

FIG. 11 is a partially exploded view of the beverage brewing apparatus of FIG. 2A showing a brew basket and showerhead;

FIG. 12 is a partially exploded view of the beverage brewing apparatus of FIG. 2A showing the brew basket and a pod adaptor in a nesting configuration;

FIG. 13A is a partially exploded front perspective view of the brew basket of the beverage brewing apparatus of FIG. 2A-2B;

FIG. 13B is a cross-sectional view of the brew basket seen in FIG. 13A, taken along section E-E of FIG. 13A, shown in the assembled configuration;

FIG. 14 is a front perspective view of the filter adaptor of the beverage brewing apparatus of FIG. 2A-2B with a showerhead removed;

FIG. 15A is a front perspective view of the beverage brewing apparatus of FIG. 2A with the showerhead resting over the filter adaptor within the brew chamber;

FIG. 15B is a front perspective view of the beverage brewing apparatus of FIG. 2A with the showerhead attached the lid of the beverage brewing apparatus;

FIG. 16 is a cross-sectional view taken along section C-C of FIG. 2B showing the brewing apparatus of FIG. 2B with the filter adaptor inserted into a brew chamber;

FIG. 17 is a front perspective view of the pod adaptor of the beverage brewing apparatus of FIG. 2A-2B;

FIG. 18 is a cross-sectional view taken along section C-C of FIG. 2B showing the brewing apparatus of FIG. 2A-2B with the pod adaptor inserted into a brew chamber;

FIG. 19 is a front perspective view of an adaptor storage container for the beverage brewing apparatus of FIG. 1A-1B;

FIG. 20A is a front perspective view of the adaptor storage container of FIG. 19 containing the filter adaptor of FIG. 7, and a corresponding adaptor storage compartment of the beverage brewing apparatus of FIG. 1A-1B;

FIG. 20B is a front perspective view of the adaptor storage container of FIG. 19 containing the pod adaptor of FIG. 9, and the corresponding adaptor storage compartment of the beverage brewing apparatus of FIG. 1A-1B;

FIG. 21 is a front perspective view of an adaptor storage container for the beverage brewing apparatus of FIG. 2A-2B;

FIG. 22A is a rear perspective view of the adaptor storage container of FIG. 21 coupled to the back of the beverage brewing apparatus of FIG. 2A-2B;

FIG. 22B is a rear perspective view of the adaptor storage container of FIG. 21 containing the pod adaptor of FIG. 17;

FIG. 22C is a rear perspective view of the adaptor storage container of FIG. 21 containing the showerhead for the filter adaptor of FIG. 14;

FIG. 23 is a cross-sectional view taken along section F-F of FIG. 2B showing lid clips of the brewing apparatus of FIG. 2A-2B engaging with the showerhead for the filter adaptor of FIG. 14;

FIG. 24 is a front perspective view of the beverage brewing apparatus of FIG. 1A showing a flexible flow path cover in an extended configuration, extending over a flow path thereof with a rigid flow path cover removed;

FIG. 25 is a front perspective view of the beverage brewing apparatus of FIG. 1A showing the rigid flow path cover in an extended configuration, extending over a flow path thereof; and

FIG. 26 is a cross-sectional view of the brewing apparatus of FIG. 1B taken along section A-A showing the flexible flow path cover and the rigid flow path cover in their respective retracted configurations.

It is noted that the drawings are not necessarily to scale. The drawings are intended to depict only typical aspects of the subject matter disclosed herein, and therefore should not be considered as limiting the scope of the disclosure.

### DETAILED DESCRIPTION

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

In general, a multi-format beverage system, and components for use in a beverage system, are provided. In one aspect, an adaptor assembly for use in a beverage system is provided and includes a filter adaptor to be used when brewing loose coffee grinds, and a pod adaptor to be used when brewing prepackaged pods. Both the filter adaptor and the pod adaptor are receivable in a brew basket that can be inserted into a brew chamber of the beverage system. The nesting configuration of the adaptors with the brew basket enable the flow of hot or cold water into each adaptor to be achieved utilizing the same brewing needle, which is located in a lid of the beverage system. Further, the adaptors are configured to interact with a drip stop such that the drip stop is active to prevent dripping during use of the filter adaptor and is inactivated during use of the pod adaptor.

The filter adaptor can also include a showerhead cover having a top surface with an opening into a hollow interior configured to receive the brewing needle of the lid when the lid is in a closed configuration. In some embodiments, the showerhead cover can be hingedly connected to the filter adaptor. The top surface of the showerhead cover can include a handle arranged away from the hinged connection to allow for the showerhead to be lifted off of the permanent adaptor and rotated about the hinged connection. In other embodiments, the showerhead cover can be separate from the filter adaptor. In this configuration, the top surface can also include a plurality of protrusions, each including an engagement feature configured to be received by a corresponding detent of a plurality of detents located on the lid of the beverage system.

In other embodiments, the beverage system can include a flexible flow path cover and/or a rigid flow path shield configured to redirect a flow of fluid to the brewing needle in the event that a brewing operation is terminated prematurely. In other embodiments, a storage system is provided for enabling one of the adaptors not in use to be stored within the beverage brewing apparatus.

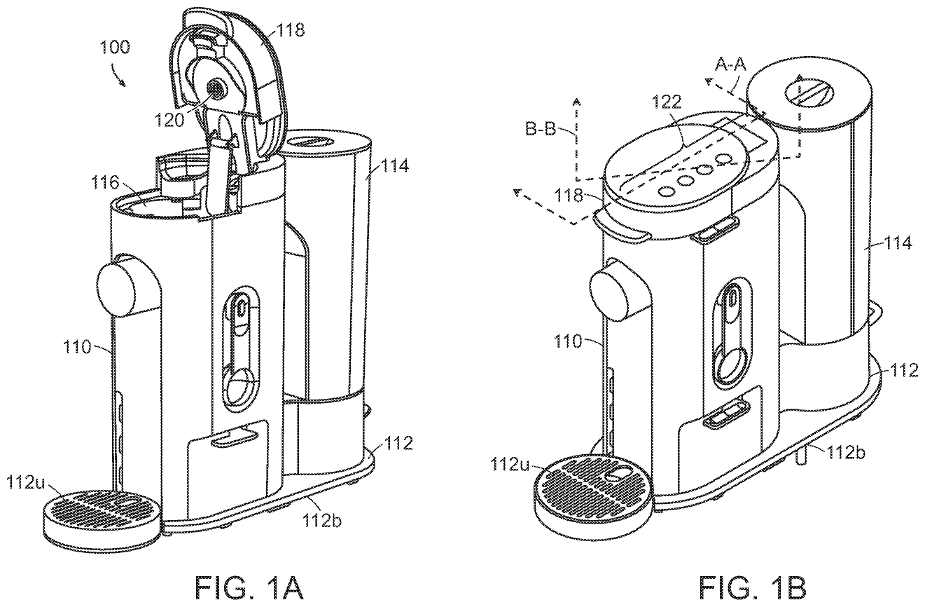

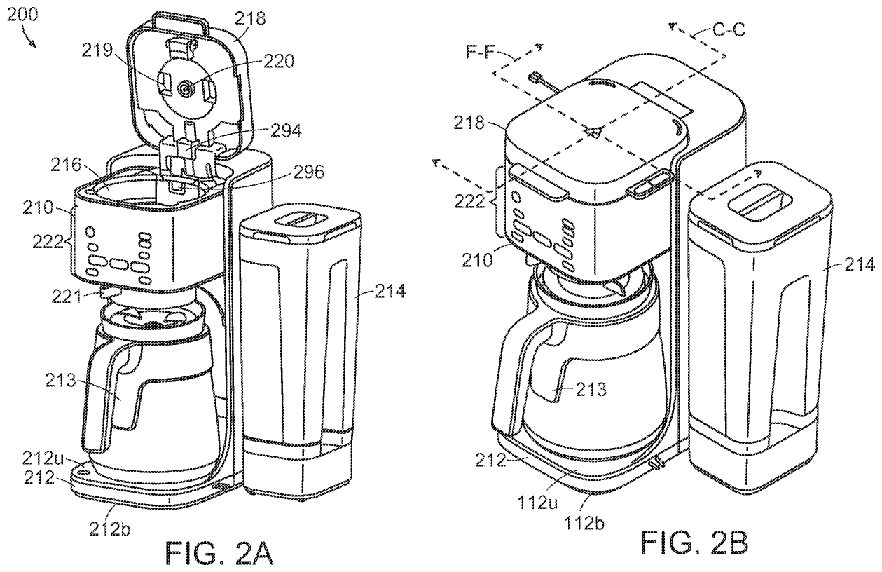

The aforementioned components and features can be utilized in a variety of beverage brewing apparatuses. FIGS. 1A-2B illustrate embodiments of a beverage brewing apparatus 100, 200 that can include any one of more of the aforementioned features. The illustrated apparatuses 100, 200 are each operable to prepare a brewed beverage, such as coffee or tea. As shown, each beverage brewing apparatus 100, 200 generally includes a housing 110, 210 having a base 112, 212. The housing 110, 210 and can be formed from a plastic or metal outer casing. A bottom surface 112b, 212b of the base 112, 212 can be configured to be positioned on a support surface, and a drip tray 112u, 212u of the base 112, 212 can define an area for positioning a container (e.g. container 213 of FIG. 2A) positioned below the brew chamber 216 and configured to receive a brewed beverage output from the beverage brewing apparatus 200, as discussed in greater detail below. In some embodiments, the drip tray 112u, 212u can have grates or a heating plate to collect fluid that drips from the container disposed thereon, or to keep the fluid in the container warm, respectively.

Each beverage brewing apparatus 100, 200 can also include a reservoir 114, 214 arranged on or coupled to the housing 110, 210 and configured to store a desired amount of fluid therein, such as water, for brewing a beverage. Each reservoir can be formed from a plastic, glass, or metal outer casing and can include a valve arranged at the bottom which is opened when the reservoirs are placed on their respective housings. Each reservoir can also include a removable lid so that the reservoir can be filed without removal form the housing. The reservoirs 114, 214 can be removably connectable to the housing for ease of filling. The reservoirs can be arranged on a side surface or back surface of the housing, but other configurations and positions of the reservoirs should be considered within the scope of this disclosure.

Each housing 110, 210 can also include a brew chamber 116, 216 within which brewing ingredients, such as coffee grinds or tea leaves, may be positioned. In some embodiments, the brew chamber 116, 216 can include a generally cylindrical cavity with a fluid outlet extending through a chamber base or a vertex formed by a sidewall of the cavity and the chamber base. The fluid outlet can be configured to deliver fluid from the brew chamber 116, 216 to the container positioned below the brew chamber 116, on the drip tray 112u, 212u, e.g., a cup or carafe. The housing 210 of brewing apparatus 200 can further include a drip-stop switch 221 (shown in FIG. 2A only). The drip-stop switch 221 can be communicatively coupled with the brew chamber 216, as will be discussed in further detail below.

Each apparatus 100, 200 can further include a lid 118, 218 configured to open and close over the brew chamber 116, 216. The lid 118, 218 can include a brewing needle 120, 220 disposed in the center thereof and configured to deliver fluid to the brew chamber 116, 216, as discussed in greater detail below.

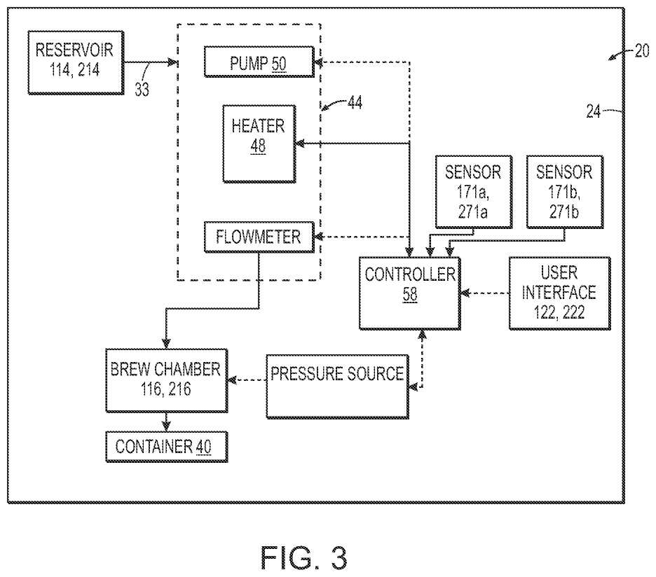

In order to prepare a beverage, each apparatus 100, 200 can further include a fluid delivery system disposed within the housing and configured to communicate fluid from the reservoir to the brew chamber. FIG. 3 illustrates a schematic of a fluid delivery system 20 that can be used in the beverage apparatuses 100, 200 of FIGS. 1A-1B and 2A-2B. As shown, the fluid delivery system 20 includes at least one fluid supply line or conduit 33 extending between an outlet end of a reservoir 114, 214 to an inlet of the brew chamber 116, 216. The fluid delivery system 20 can also include a heater 48 operable to heat the water supplied from the reservoir 114, 214 to a desired temperature prior to delivery to the brew chamber 116, 216. Additionally, the fluid delivery system 20 can include a pumping mechanism 50 operable to provide a positive pumping action to push or draw a fluid, such as water, from the reservoir 114, 214 through the at least one fluid supply line 33 and the heater 48 to deliver the fluid to the brew chamber 116, 216. In some embodiments, the at least one fluid supply line 33 can be configured to terminate at the lid 118, 218 of the housing. As will be discussed in detail below, the lid of the housing can be configured to open and close over the brew chamber, and the fluid supply line can be configured to terminate at a brewing needle 120, 220 disposed on the bottom surface of the lid 118, 218.

The beverage brewing apparatuses 100 and 200 can also include a user interface 122, 222 for receiving one or more inputs from a user. The user interface 122, 222 can be formed at a portion of the housing. In the apparatus 100 of FIG. 1A-1B, a user interference 122 is formed at a top surface of the lid 118. In the apparatus 200 of FIG. 2A-2B, a user interface 222 is formed at a front surface of the housing 210, adjacent the brew chamber 216. The user interface 122, 222 can, however, be located anywhere on the housing 210 and the position can vary depending on the configuration of the beverage brewing apparatus. The user interface 122, 222 can include one or more buttons, knobs, or other control input devices. Alternatively, or in addition, the user interface can include a touch screen, or it can be configured to receive an input via from a smart device, such as a phone or tablet for example, via an “app” or other suitable connection.

Referring back to FIG. 3, operation of a beverage brewing apparatus 100, 200 can be controlled by a controller 58 operably coupled to the components of the beverage brewing apparatus, and configured receive one or more input signals from the user interface. The controller 58 can include one or more of a microprocessor, microcontroller, application specific integrated circuit (ASIC), or any other form of electronic controller known in the art.

A person skilled in the art will appreciate that the features disclosed herein can be used in a beverage brewing apparatus having a variety of other configurations, and that the illustrated beverage brewing apparatus is merely one exemplary embodiment. Other embodiments of beverage brewing apparatuses are disclosed in U.S. Pat. No. 11,246,446, titled “Hybrid Receptacle Beverage Brewing System,” filed on Dec. 31, 2020, which is hereby incorporated by reference in its entirety.

### Adaptor Assembly

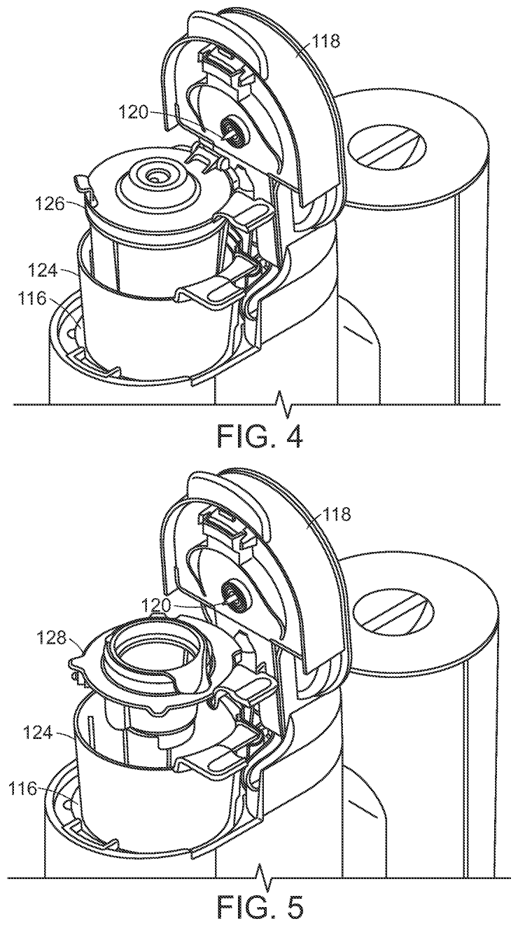

As indicated above, an adaptor assembly is provided for use in a beverage brewing apparatus, such as apparatus 100 of FIG. 1A-1B. FIGS. 4-10 illustrate one exemplary embodiment of an adaptor assembly. As shown in FIGS. 4 and 5, the beverage brewing apparatus 100 includes a brew basket 124 that is configured to separately seat a filter adaptor 126 and a pod adaptor 128 for allowing the apparatus 100 to selectively brew a beverage from grounds or from a pod. A pod can be any form of sealed package containing an amount of brewing ingredients, where the outer package is pieced or fluid preamble to allow fluid to enter the package and interact with the brewing ingredients to form a brewed beverage.

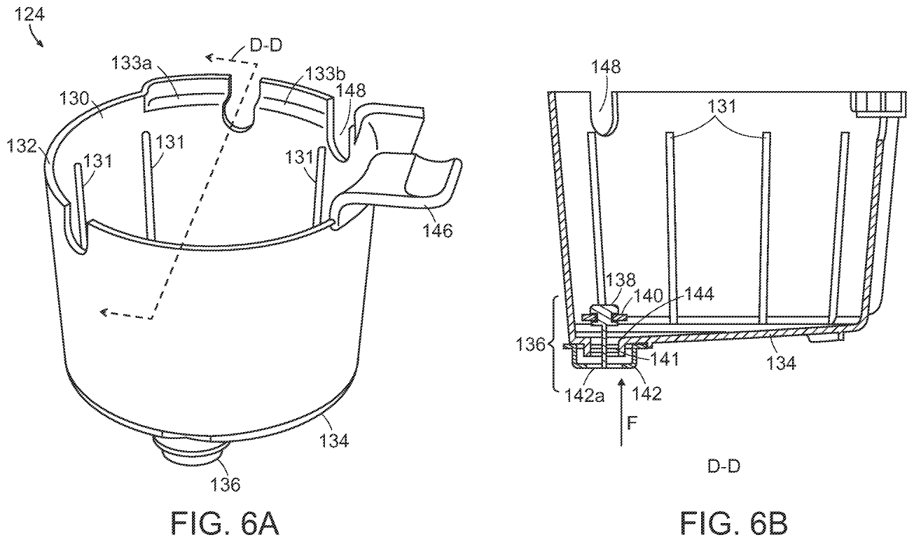

As shown in FIG. 6A, the illustrated the brew basket 124 is generally cup-shaped with a generally cylindrical cavity 130 and a basket rim 132, a basket base 134, and a drip-stop valve 136 extending through an opening 141 in the basket base 134. The brew basket 124 can further include a handle 146 extending radially outward from the basket rim 132 and configured to allow a user to easily place and remove the brew basket 124 into and from the brew chamber 116. In some embodiments, the brew basket 124 can further include at least one cut-out or slot 148 in the basket rim 132 that is configured to allow at least one engagement feature of the pod adaptor to pass there through to engage with the brew chamber 116, as will be discussed in greater detail below. The brew basket 124 can also include a first sensor plate 133a and a second sensor plate 133b configured to receive a first indication marker of the filter adaptor 126 and a second indication marker of the pod adaptor 128 second adaptor, respectively, as will be discussed in greater detail below.

FIG. 6B is a cross-sectional view of the brew basket 124 taken along section D-D of FIG. 6A. As seen in FIG. 6B, the illustrated drip-stop valve 136 includes a piston 138 extending through the opening 141. The drip-stop valve 136 can further include a drip-stop seal 140 disposed within the cavity. The drip-stop seal 140 can be in the form of a circular flexible gasket configured to extend radially outward from the piston to seal an opening 141 that the piston passes through. The drip-stop valve 136 can further include a biasing end 142 located opposite the drip-stop seal 140. The biasing end 142 can be in the form of circular flange extending radially outward from the piston. The biasing end 142 can further include a plurality of openings 142a configured to allow fluid to pass through the bottom of the biasing end 142 when the drip-stop valve 136 is in the open configuration. In some embodiments, the piston 138 and the biasing end 142 can be formed integrally. The drip-stop valve 136 can further include a spring 144 positioned about the piston 138, extending between the biasing end 142 and the base 134 of the brew basket 124. The spring 144 can be configured to apply a biasing force between the biasing end 142 and the base 134, to push them apart. Referring back to FIG. 4, with the lid 118 open and the brew basket 124 simply sitting in the brew chamber 116, the drip-stop valve 136 is biased by the spring to a closed configuration with the drip-stop seal 140 sealing off the opening 141 within the brew basket 124. However, when a compressive force F is applied to the biasing end 142, the drip-stop valve 136 is moved to an open position, thus allowing fluid to flow though the opening 141 and the openings 142a.

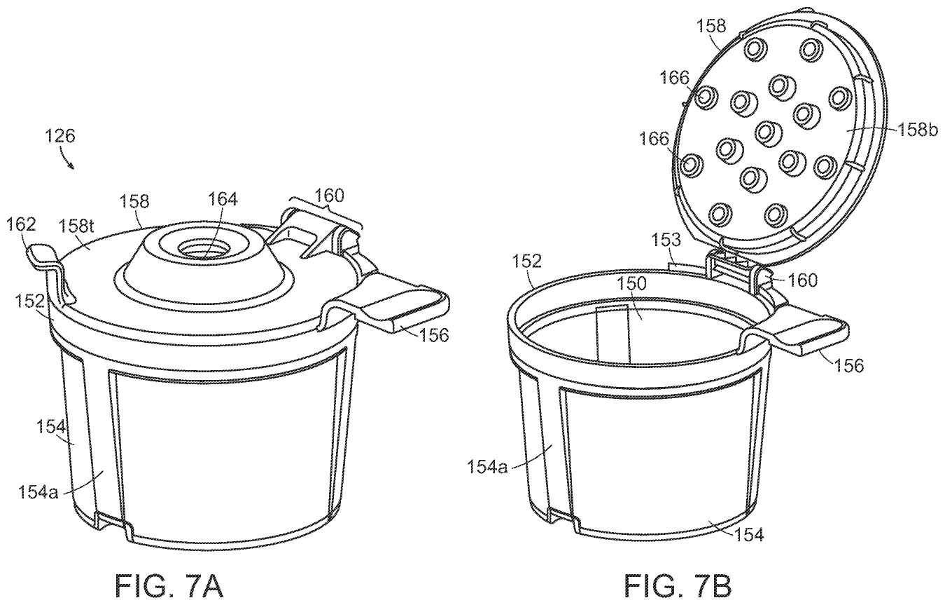

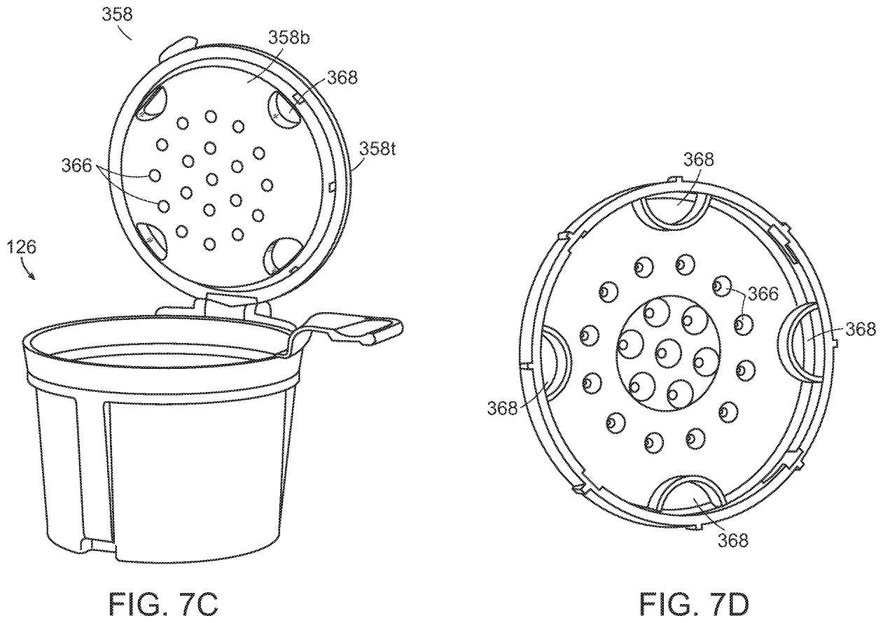

As indicated above, the brew basket 124 can be configured to selectively seat the filter adaptor 126 and the pod adaptor 128. As shown in FIGS. 7A-7B, the filter adaptor 126 can be in the form of a generally hollow cylindrical housing having a generally cylindrical cavity 150 configured to hold brewing ingredients. The illustrated filter adaptor 126 has a filter rim 152 at an upper end that defines an opening to the cavity 150. One or more portions of the walls 154 of the cavity 150 of the filter adaptor 126 can be at least partially made of a porous or perforated material to allow fluid to pass there through, while maintaining the brewing ingredients within the cavity. Additionally, the filter adaptor 126 can include supports 154a extending downward from the filter rim 152 to support and provide attachment points form the wall 154. The filter adaptor 126 can be configured to be placed within the brew basket 124 during a brewing operation with a lower surface of the filter rim 152 arranged to rest on top of one or more internal radial ribs 131 provided on within the cavity 130. The filter adaptor 126 can also include a first indication marker 153 configured to be received by the first sensor plate 133a of the brew basket 124 (as shown in FIG. 6A). The first indication marker can be configured to be detected by a corresponding sensor disposed within the brew chamber 116, as discussed in greater detail below, to indicate to the apparatus 100 that the filter adaptor 126 is being used. In some embodiments, the first indication marker 153 can be a magnet or a material detectable by an induction sensor.

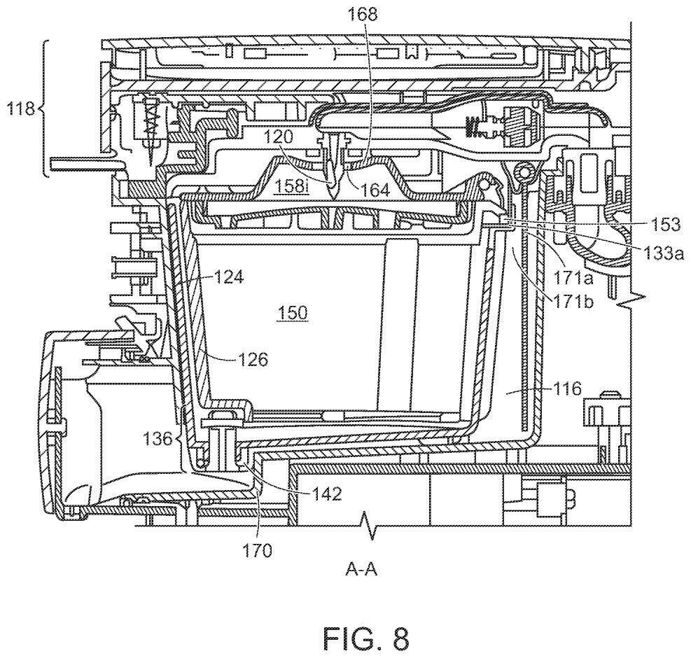

As further shown, the filter adaptor 126 can include a handle 156 extending radially outward therefrom and positioned on the filter rim 152 and configured to fit symmetrically next to the handle 146 of the brew basket. The filter adaptor 126 can further include a showerhead 158 configured to hingedly attach to the filter rim 152 at a hinged connection 160. The illustrated showerhead 158 includes a top 158t, and a bottom 158b spaced a distance apart from one another. In between the top 158t and the bottom surface 158b is a hollow interior 158i (shown in FIG. 8). The top 158t can include a handle 162 arranged away from the hinged connection 160 to allow for the showerhead 158 to be lifted up off of the rim 152 of the filter adaptor 126 and rotated about the hinged connection 160. The top 158t can also include an opening 164 into the hollow interior 158i configured to receive the brewing needle 120 of the lid 118 when the lid is in a closed configuration, thus allowing fluid to be delivered into the hollow interior 158i. The bottom 158b of the showerhead 158 can include a plurality of openings 166 extending there through. The plurality of openings 166 can be configured to disperse a flow of fluid delivered to the hollow interior 158i from the brewing needle 120 via the opening 164 into the cavity 150 of the filter adaptor 126 during a brewing operation. In some embodiments, the showerhead top 158t and the showerhead bottom 158b can be configured to be separated in order to clean the hollow interior 158i.

FIGS. 7C-7D, illustrate another embodiment for a showerhead 358 that can be used with the filter adaptor 126. Accordingly, like components will not be described in detail. The illustrated showerhead 358 includes a bottom surface 358b and a top surface 358t, spaced a distance apart from one another. In between the top surface 358t and the bottom surface 358b is a hollow interior. In some embodiments, the hollow interior of the showerhead 358 can be similar to the hollow interior 158i of shown in FIG. 8. The bottom surface 358b of the showerhead 358 can include a plurality of openings 366 extending there through. In some embodiments, the openings 366 can be similar to the openings 166 of the showerhead 158 shown in FIG. 7B. The showerhead bottom surface 358b can further include at least one overflow hole 368 located around an edge 358e of the bottom surface 358b of the showerhead 358, radially offset from the openings 366. The overflow hole(s) 368 can be sized larger than the openings 366 to allow for fluid to flow there through in the event that the openings 366 become blocked or clogged. In some embodiments, the showerhead top surface 358t and the showerhead bottom surface 358b can be configured to be separated in order to clean the hollow interior 358i.

As indicated above, the filter adaptor 126 is configured to be placed within the brew basket 124, and the brew basket 124 is configured to be placed within the brew chamber 116. A user can place loose brewing ingredients within the cavity 150 of the filter adaptor 126 and close the showerhead 158. The user can then close the lid 118 to begin the brewing process. FIG. 8 is a cross-sectional view of the brewing apparatus 100 shown along section A-A of FIG. 1B, with the filter adaptor 126 therein. As shown in FIG. 8, when the lid 118 is in the closed configuration, the brewing needle 120 is received by the opening 164. A flexible gasket 168 can be provided around the brewing needle 120 to form a tight seal around the opening 164. A downward pressure applied to the filter adaptor 126 and the brew basket 124 from the lid 118 being closed causes the filter adaptor 126 and the brew basket 124 to move toward a base of the brew chamber 170. The biasing end 142 of the drip-stop valve 136 can be configured contact the base of the brew chamber 170 and bias the drip-stop valve 136 to the open position. Accordingly, when the lid 118 is in the closed configuration, the drip-stop valve 136 is maintained in the open configuration, allowing brewed fluid to flow from the brew basket 124 into the brew chamber 116.

Still referring to FIG. 8, in the closed configuration, a filter adaptor sensor 171a disposed within the brew chamber 116 can be configured to detect the first indication marker 153 through the first sensor plate 133a. Detection of the first indication marker 153 by the filter adaptor sensor 171a can indicate to the controller 58 (as shown in FIG. 3) of the apparatus that the filter adaptor 126 is present within the brew chamber 116.

The user can activate the apparatus to begin the brewing process, whereby fluid flows from the brewing needle 120, into the hollow opening 158i of the showerhead, through the plurality of openings 166, and into the filter adaptor 126 where it can interact with the loose brewing ingredients in order to brew coffee or tea. The brewed beverage can then flow from the filter adaptor 126 through the perforated material of the walls 154 and into the brew basket 124. The brewed beverage present in the brew basket 124 then flows through the openly biased drip-stop valve 136 into the brew chamber 116, where it can then be delivered to a container configured to receive the brewed beverage.

When the brewing process is finished the lid 118 can be opened, relieving the pressure on the filter adaptor 126 and the brew basket 124, allowing the drip-stop valve 136 to bias back to a closed configuration so that fluid is prevented from flowing through the valve 136. Similarly, if the lid 118 is opened before the brewing process is complete, the drip-stop valve 136 can be configured to bias back to a closed configuration. In this case, any fluid that is present in the filter adaptor 126 can be configured to filter into the brew basket 124 and be held there until the either the lid 118 is closed, or the brew basket 124 is removed for cleaning.

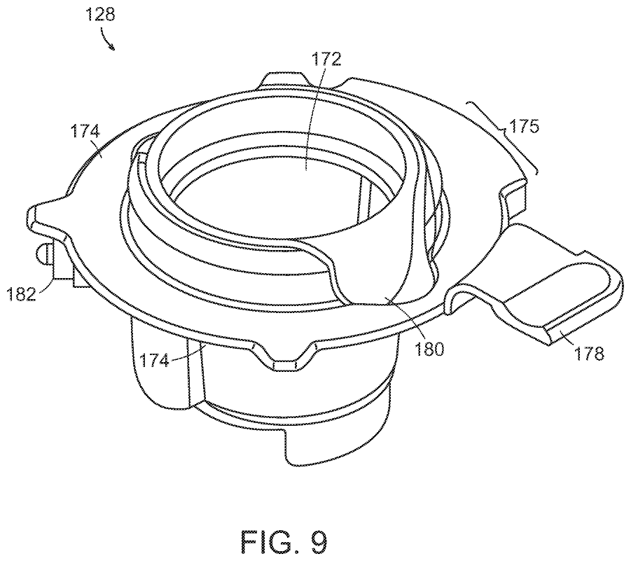

As indicated above, the brew basket 124 can also be configured to receive a pod adaptor 128. As illustrated in FIG. 9, the pod adaptor 128 is in the form of a generally cylindrical housing having a generally cylindrical cavity 172 configured to hold a prepackaged pod of brewing ingredients. The pod adaptor 128 can have a rim 174 in the form of a radially projecting flange on an upper end thereof to facilitate placement of the pod adaptor 128 within the brew basket 124. The pod adaptor 128 can be configured to be placed within the brew basket 124 during a brewing operation with an underside surface of the rim 174 arranged to rest on the basket rim 132. The pod adaptor 128 can also include a second indication marker 175 configured to be received by the second sensor plate 133b of the brew basket 124 (as shown in FIG. 6A). In some embodiments, the second indication marker 175 can be a magnet or similarly to the filter adaptor sensor 171a (as shown in FIG. 8), a pod adaptor sensor 171b is disposed within the brew chamber 116 (located adjacent to the filter adaptor sensor 171a) and can be configured to detect a second indication marker of the pod adaptor 128 through the second sensor plate 133b.

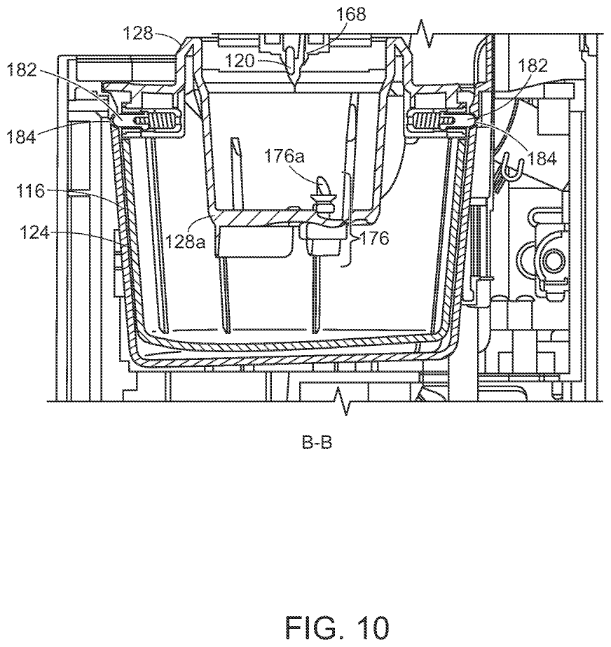

As illustrated in FIG. 10, in some embodiments, a cavity of the pod adaptor can include a pod puncturing apparatus 176 configured to puncture a bottom surface of a prepackaged pod placed therein. The pod puncturing apparatus 176 includes a needle 176a having a hollow lumen therethrough that allows fluid within a punctured pod to pass through the outer surface 128a of the pod adaptor 128 and into the brew chamber 116.

Referring back to FIG. 9, the pod adaptor 128 can further include a handle 178 placed near the rim 174 and configured to fit symmetrically next to the handle 146 of the brew basket 124. As shown, the handle 178 can project radially outward from the rim 174. As further shown in FIG. 9, the pod adaptor rim can further include one or more openings 180 around the outside of the cavity 172 that extend through the pod adaptor 128 to the cavity 130 of the brew basket 124 when inserted in the brew basket. The one or more openings 180 can be configured to funnel any excess or errand fluid that may accumulate on the pod adaptor rim 174 into the brew basket 124.

The pod adaptor 128 can further include at least one engagement 182 feature configured to be received by a corresponding detent 184 provided within the brew chamber 116. The detents 184 are provided within the brew chamber 116 in order to lock the pod adaptor 128 relative to the brew chamber 116. As shown in FIG. 9, the at least one engagement feature 182 can be disposed beneath the pod adaptor rim 174, outside of the cylindrical cavity 172, and extend radially outward from the outer surface 128a of the pod adaptor 128. The at least one engagement feature 182 can be arranged to pass through the corresponding slot 148 cut out on the basket rim 132 of the brew basket 124 and engage with the corresponding detent 184.

As shown in FIG. 10, the pod adaptor 128 includes first and second engagement features 182 arranged opposite one another around the outside of the cavity 172. Each engagement feature is in the form of a spring-loaded projection that is configured to engage a corresponding detent 184 of the brew chamber. Each detent in the brew chamber can be in the form of a small hole extending partially through the sidewall of the brew chamber and arranged near the upper rim of the brew chamber. A person skilled in the art will appreciate that any number of engagement features can be utilized, and that the projection and detent can be reversed, and further that other engagement features can be used.

To perform a brewing operation with the pod adaptor 128, the brew basket 124 can be placed within the brew chamber 116 with slots 148 aligned with the corresponding detents 184 of the brew chamber. The pod adaptor 128 can be placed within the brew basket 124 with the engagement features 182 aligned with the corresponding slots 148 and detents 184. By applying a downward pressure on the pod adaptor 128 and brew basket 124 while they are within the brew chamber 116, the engagement features 182 can pass through slots 148 and be received by the corresponding detents 184, thereby retaining the pod adaptor 128 within the brew chamber 116 in a locked configuration. By locking the pod adaptor 128 and the brew basket 124 relative to the brew chamber 116, the drip-stop valve 136 of the brew basket can also be locked in an open configuration. In some embodiments, a brewing operation can be performed with the pod adaptor 128 without using the brew basket 124. Similarly, in this embodiment, the pod adaptor 128 can be placed within the brew chamber 116 with the engagement features 182 aligned with the corresponding detents 184.

Additionally, in the locked configuration, the pod adaptor sensor 171b (as shown in FIG. 8) can be configured to detect the second indication marker 175 (as shown in FIG. 9) through the second sensor plate 133b (as shown in FIG. 4A) and indicate to the controller 58 (as shown in FIG. 3) of the apparatus, that the pod adaptor 128 is being used. The user interface display 122 can be configured to change based on which indication marker, of the first indication marker 153 and the second indication marker 175, is detected by the filter adaptor sensor 171a or the pod adaptor sensor 171b, respectively.

In use, a prepackaged pod can be placed within the cavity 172 of the pod adaptor 128, either prior to or after insertion of the pod adaptor 128 and the brew basket 124 into the brew chamber 116. The lid 118 can then be closed and the brewing needle 120 can be configured to puncture a top side of the prepackaged pod. The downward force applied to the top of the pod can push the pod downward within the cavity 172 of the pod adaptor, into the puncturing apparatus 176. It can be advantageous for the pod adaptor 128 to be in a locked configuration relative to the brew chamber 116 so that the brewing needle 120 can reliably puncture that same location on the top of the prepackaged pod as the lid is closed. The user can then activate a brewing process, and fluid can flow out of the brewing needle 120 and into the prepackaged pod to prepare the brewed beverage. Once properly brewed, the brewed beverage can flow out of the puncturing apparatus 176, through the open drip-stop valve 136 into the brew chamber 116, where it can then be delivered to a container configured to receive the brewed beverage.

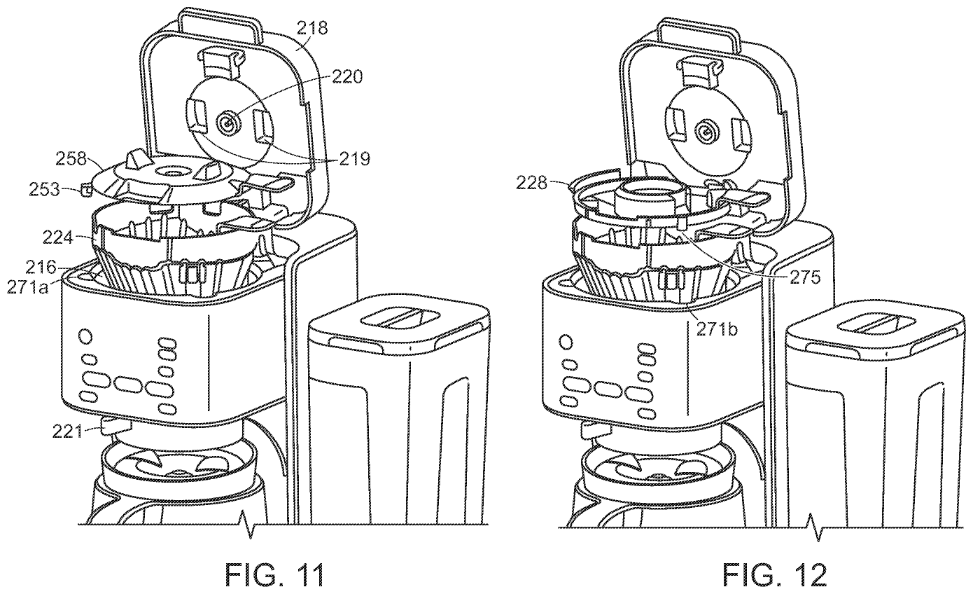

FIGS. 11-17 illustrate another exemplary embodiment of an adaptor assembly for use with a beverage brewing apparatus, such as apparatus 200 of FIG. 2A-2B. As shown in FIGS. 11 and 12, the beverage brewing apparatus 200 includes a brew basket 224 that is configured to separately operate with a showerhead 258 and a pod adaptor 228 for allowing the apparatus 200 to selectively brew a beverage from grounds or from a pod.

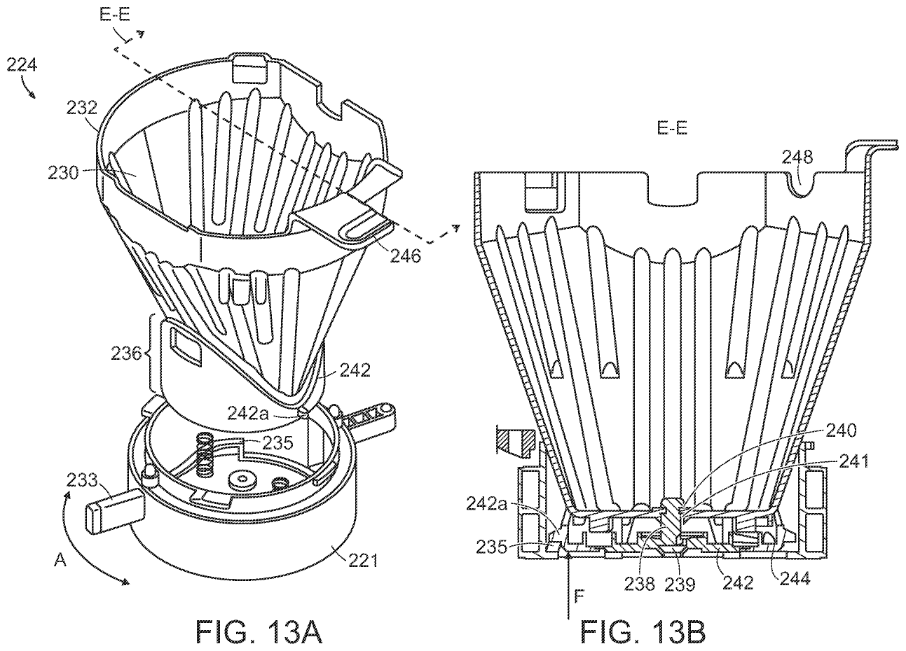

FIG. 13A shows the brew basket 224 in more detail. As shown, the brew basket 224 has a generally conical cavity 230 with a basket rim 232 and a basket base 234. In some embodiments, the shape of the cavity 230 can resemble the shape of a traditional paper coffee filter. The brew basket 224 can further include a handle 246 projecting radially outward from the basket rim 232 and configured to allow a user to easily place and remove the brew basket 224 within and from the brew chamber 216. In some embodiments, the brew basket 224 can further include at least one cut-out or slot 248 in the basket rim of the brew basket configured to allow at least one engagement feature of the pod adaptor to pass there through to engage with the brew chamber 216, as will be discussed in greater detail below. The brew basket 224 can also include drip-stop valve 236, which, together with the drip-stop switch 221, form a drip-stop assembly 237. The drip-stop valve 236 can include a biasing end 242 including at least one tab 242a configured to interact with the drip-stop switch 221 to move the drip-stop valve 236 as discussed below. The illustrated drip-stop switch 221 includes a lever 233 and at least one ramp 235 formed thereon configured to move the drip-stop valve 236 vertically to seal and unseal the drip-stop valve 236. The lever 233 can be rotated back and forth along path A to rotate the drip-stop switch 221. As the drip-stop switch 221 rotates, the ramp 235 can be configured to come into contact with the tab 242a. As the tab 242a contacts the ramp 235, it can be configured to slide up the ramp 235, thereby moving the biasing end 242 in a vertical direction to seal and unseal the drip-stop valve 236.

FIG. 13B is a cross sectional view of the brew basket 224 taken along section E-E of FIG. 13A. As shown in FIG. 13B, the base of the brew basket 224 can include an opening 241. The drip-stop valve 236 can further include a piston 238 extending through the opening 241. The piston 238 can include a fluid passage 239 configured to allow fluid to pass through the piston 238 when the drip-stop valve 236 is in an open configuration. The drip-stop valve 236 can further include a drip-stop seal 240 disposed within the cavity, and the biasing end 242 located opposite the drip-stop seal 240, similar to drip-stop valve 136. The drip-stop seal 240 can be in the form of a circular flexible gasket configured to extend radially outward from the piston 238 to seal the opening 241 when the drip-stop valve 236 is in a closed configuration. As discussed above, the biasing end 242 can further include tabs 242a configured to be moved vertically by the force F, generated by the ramps 235 as the drip-stop switch 221 is rotated in the direction A (as shown in FIG. 13A). In some embodiments, the piston 238 and the biasing end 242 can be formed integrally. The drip-stop valve 236 can further include at least one spring 244 wrapped around the piston 238 in between the drip-stop seal 240 and the biasing end 242. When a compressive force F is applied to the biasing end 242, the drip-stop valve 236 can be biased to an open position, and fluid can flow though the opening.

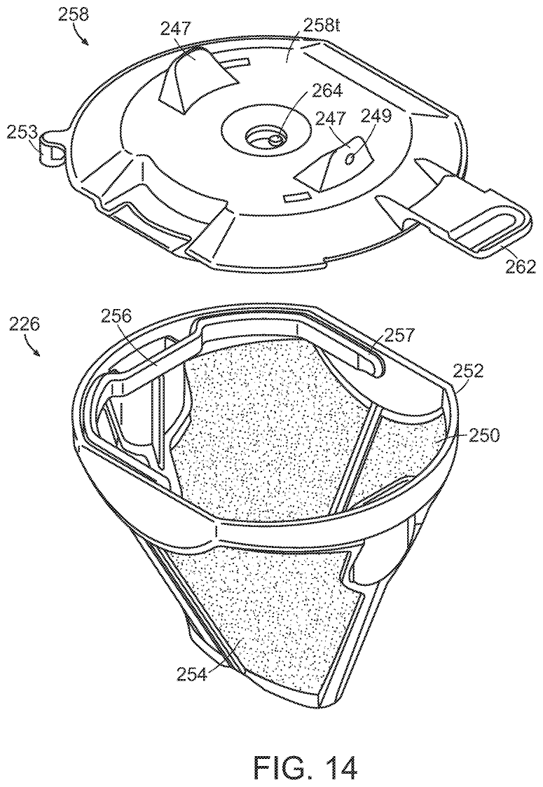

As indicated above, the brew basket 224 can be configured to selectively seat the filter adaptor 226 and the pod adaptor 228. As shown in FIG. 14, the filter adaptor 226 can be in the form of a generally conical housing having a generally conical cavity 250 configured to hold loose brewing ingredients. The filter adaptor 226 can have a filter rim 252 at an upper end that defines an opening to the cavity 250. The walls 254 of the filter adaptor 226 can be at least partially made of a porous or perforated material to allow fluid to pass through the cavity, while maintaining the brewing ingredients within the cavity. The filter adaptor 226 can be configured to be placed within the brew basket 224 during a brewing operation. It should be noted that a brewing operation can also be performed using a traditional paper coffee filter, or the like, in place of the filter adaptor 226. In some embodiments, the filter adaptor 226 can include a handle 256 mounted on an inner surface of the filter rim 252 by two pins 257. The handle 256 can be configured to rotate about pins 257. The handle 256 can be rotated upward to pull the filter adaptor 226 out of the brew basket 224, or can be nested within the filter adaptor 226 (as shown in FIG. 14) during a brewing operation.

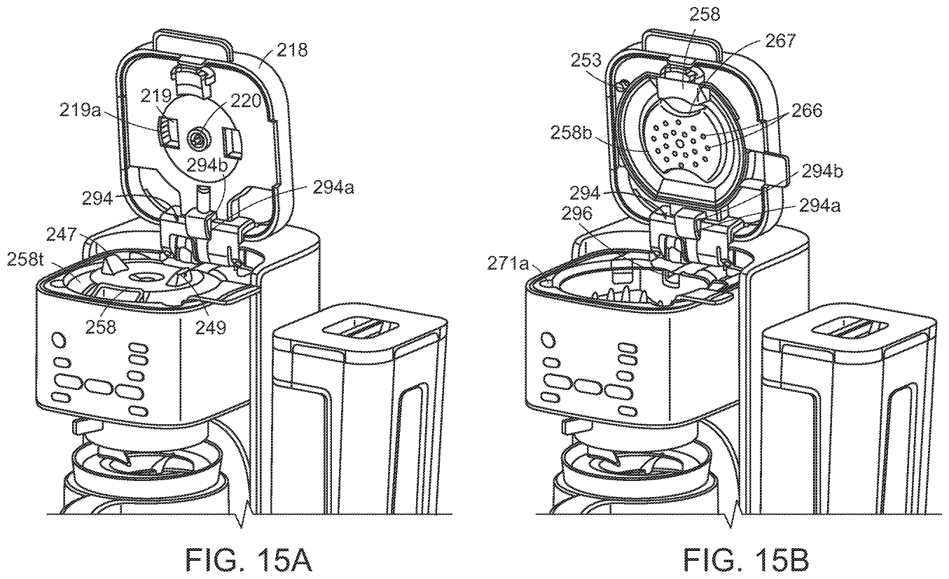

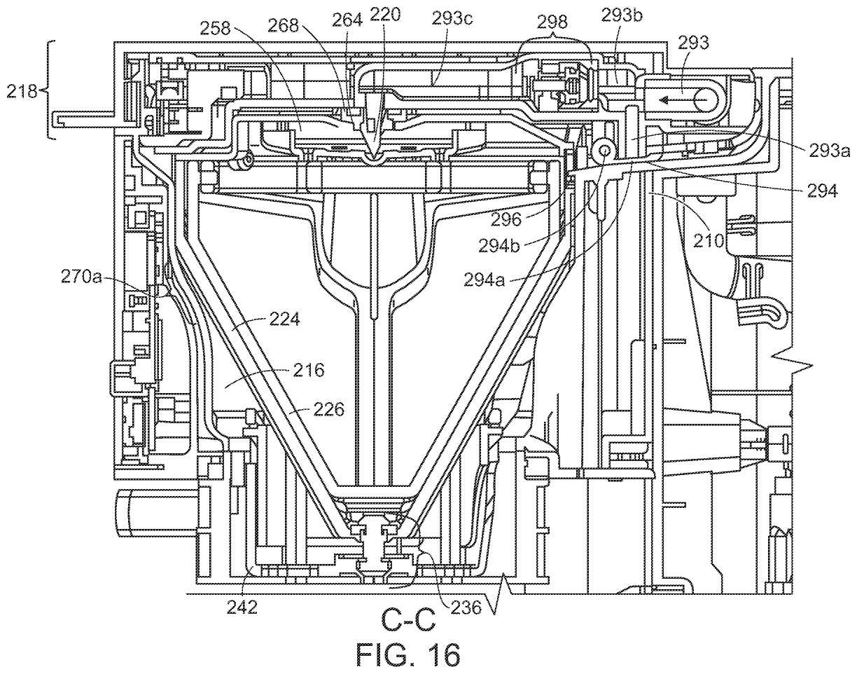

The filter adaptor 226 can further include a showerhead 258 configured to be used in combination with the filter adaptor 226 during a brewing operation. The illustrated showerhead 258 includes a top surface 258t and a bottom surface 258b (as shown in FIG. 15B) that are spaced a distance apart from one another. In between the top surface 258t and the bottom surface 258b is a hollow interior 258i (as shown in FIG. 16). The top surface 258t can include a handle 262 to allow for the showerhead 258 to be lifted up off of the rim 252 of the filter adaptor 226. The handle 262 can be configured to fit symmetrically next to the handle 246 of the brew basket. The top surface 258t can also include protrusion portions 247 configured to engage with lid clips 219 (as shown in FIG. 11), as will be discussed in greater detail below. The top surface 258t can also include an opening 264 into the hollow interior 258i configured to receive the brewing needle 220 of the lid 218 when the lid is in a closed configuration, thus allowing fluid to be delivered into the hollow interior 258i. As shown in FIG. 15B, the bottom surface 258b of the showerhead 258 can include a plurality of openings 266 extending through the bottom surface 258b. The plurality of openings 266 can be configured to disperse a flow of fluid delivered to the hollow interior 258i from the brewing needle 220 via the opening 264 into to the cavity 250 of the filter adaptor 226 during a brewing operation. The showerhead bottom surface 258b can further include at least one overflow hole 267. The overflow hole(s) 267 can be sized larger than the openings 266 to allow for fluid to flow there through in the event that the openings 266 become blocked or clogged. In some embodiments, the showerhead top surface 258t and the showerhead bottom surface 258b can be configured to be separated in order to clean the hollow interior 258i.

The showerhead 258 can further include a first indication marker 253 configured to be received by the filter adaptor sensor 271a (as shown in FIG. 11), as will be discussed in greater detail below.

The filter adaptor 226 is configured to be placed within the brew basket 224, and the brew basket 224 can be placed within the brew chamber 216. A user can place loose brewing ingredients within the cavity 250 of the filter adaptor 226 and position the showerhead 258 over the filter adapter 226. The user can then close the lid 218 to begin the brewing process. FIG. 16 is a cross-sectional view of the brewing apparatus 200 shown along section C-C of FIG. 2B. As shown in FIG. 16, when the lid 218 is in the closed configuration, the brewing needle 220 is received by the opening 264. A flexible gasket 268 can be provided around the brewing needle 220 to form a tight seal around the opening 264. A downward pressure applied to the filter adaptor 226 and the brew basket 224 from the lid 218 being closed causes the filter adaptor 226 and the brew basket 224 to move toward a base of the brew chamber 270 and to come into contact with an angled portion 270a of the brew chamber 270. With the lid 218 in the closed configuration and the brew basket 224 in contact with the angled portion 270a of the brew chamber 270, a user can move the lever 233 back and forth along path A (as shown in FIG. 13A). By moving the lever 233 back and forth along path A, the at least one ramp 235 can progressively move the biasing end 242 of the drip-stop valve 236 vertically relative to the rest of the brew basket 224 to seal and unseal the drip-stop valve 236.

Referring back to FIG. 11, the filter adaptor sensor 271a can be configured to detect the first indication marker 253 to indicate to the controller of the apparatus 200 that the filter adaptor 226 is present in the brew chamber 216. The user can activate the apparatus to begin the brewing process, whereby fluid flows from the brewing needle 220, into the hollow interior 258i of the showerhead, through the plurality of openings 266, and into the filter adaptor 226 where it can interact with the loose brewing ingredients in order to brew coffee or tea. The brewed beverage can then flow from the filter adaptor 226 through the perforated material 254 into the brew basket 224. The user can then move the lever 233 back and forth along path A to open and close drip-stop valve 236 to control the flow of fluid into the brew chamber 216, where it can then be delivered to a container configured to receive the brewed beverage.

When the brewing process is finished the user can move the lever 233 to close the drip-stop valve 236 so that fluid is retained within the brew basket 224. In this case, any fluid that is present in the filter adaptor 226 can be configured to filter into the brew basket 224 and be held there until the either the lid 218 is closed, or the brew basket 224 is removed for cleaning. In the event that the lid 218 is opened before the brewing process is complete, the brewing system can be configured to enter a controlled ramp down process, rather than an immediate shutdown, to protect the brewing system equipment.

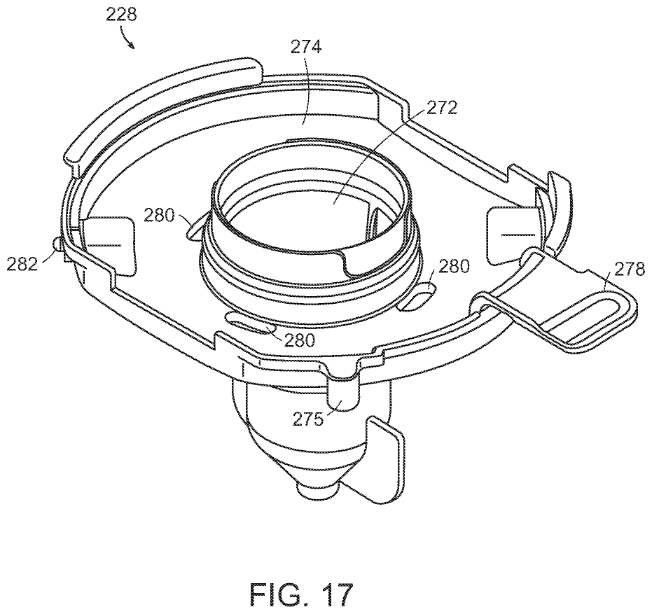

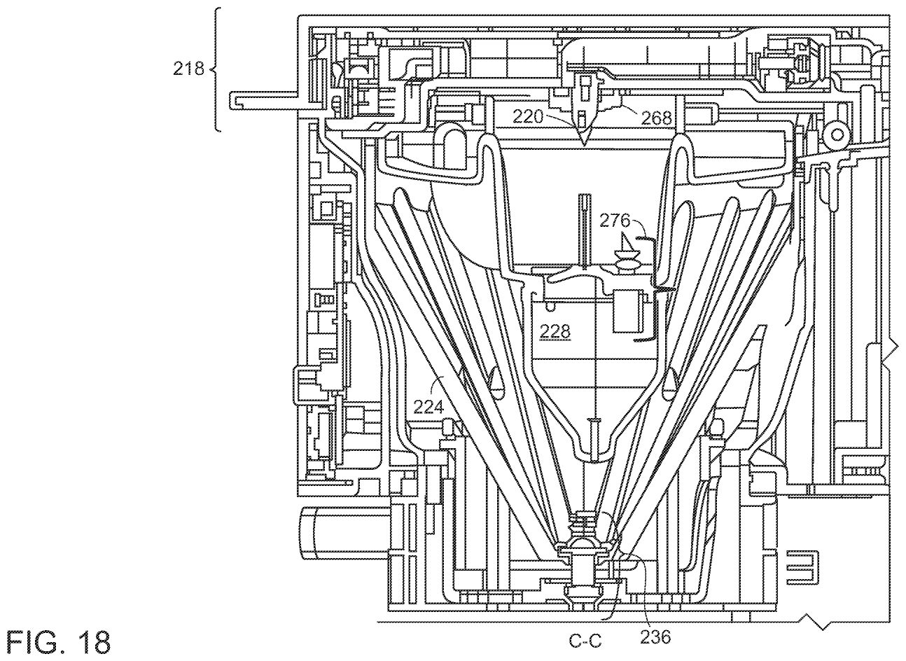

As indicated above, the brew basket can also be configured to receive a pod adaptor 228. As shown in FIG. 17, the illustrated pod adaptor 228 is in the form of a generally cylindrical housing having a generally cylindrical cavity 272 configured to hold a prepackaged pod of brewing ingredients. The pod adaptor 228 can have a rim 274 on an upper end thereof to facilitate placement of the pod adaptor 228 within the brew basket 224. The pod adaptor 228 can be configured to be placed within the brew basket 224 during a brewing operation with an underneath of the filter rim 274 arranged to rest on the basket rim 232. In some embodiments, the cavity of the pod adaptor 228 can include a pod puncturing apparatus 276 (as shown in FIG. 18) configured to puncture a bottom surface of a prepackaged pod placed therein. The pod puncturing apparatus 276 is similar to the pod puncturing apparatus 176, as described above. The pod adaptor 228 can further include a handle 278 placed near the rim 274 and configured to fit symmetrically next to the handle 246 of the brew basket 224. As shown, the handle 278 can project radially outward from the rim 274. As shown in FIG. 17, the pod adaptor rim 274 can include one or more openings 280 around the outside of the cavity 272 that extend through the pod adaptor 228 to the cavity 230 of the brew basket 224 when inserted in the brew basket. The one or more openings 280 can be configured to funnel any excess or errand fluid that may accumulate on the pod adaptor rim 274 into the brew basket 224.

The pod adaptor 228 can further include a second indication marker 275. The second indication marker 275 can be similar to the first indication marker 253 (as shown in FIG. 14). The second indication marker 275 can be configured to be received by a pod adaptor sensor 271b, as will be discussed in greater detail below.

The pod adaptor 228 can further include at least one engagement 282 feature configured to be received by a corresponding detent 284 provided within the brew chamber 216. The detents 284 are provided within the brew chamber 216 in order to lock the pod adaptor 228 relative to the brew chamber 216. As shown, the at least one engagement feature 282 can be disposed beneath the pod adaptor rim 274, outside of the cylindrical cavity 272. The at least one engagement feature can be arranged to pass through the corresponding slot 248 cut out on the upper rim 232 of the brew basket 224 and engage with the corresponding detent 284. The at least one engagement 282 feature can be configured to engage with the detents 284 similarly to how the at least one engagement feature 182 interacts with the detents 184 of apparatus 100 (as shown in FIG. 10). In use, the pod adaptor 228 can be placed within the brew basket 224 with the engagement features 282 aligned with the corresponding slots 248. The brew basket 224 can be placed within the brew chamber 216 with slots 248 aligned with the corresponding detents 284 of the brew chamber, and the engagement features 282 can be configured to engage with the corresponding detents 284 as discussed in greater detail below.

FIG. 18 is a cross-sectional view of the brewing apparatus 200 shown along section C-C of FIG. 2B. As seen in the embodiment shown in FIG. 18, the pod adaptor 228 includes first and second engagement features 282 arranged opposite one another around the outside of the cavity 272. The engagement features 282 are sustainably similar to engagement features 182, and interact with the brew chamber 216 in the same fashion that engagement features 182 interact with the brew chamber 116. Each engagement feature 282 is in the form of a spring-loaded projection that is configured to engage a corresponding detent 284 of the brew chamber. Each detent in the brew chamber can be in the form of a small hole extending partially through the sidewall of the brew chamber and arranged near the upper rim of the brew chamber. A person skilled in the art will appreciate that any number of engagement features can be utilized, and that the projection and detent can be reversed, and further that other engagement features can be used.

To perform a brewing operation, the pod adaptor 228 and brew basket 224 can be place within the brew chamber 216, as discussed above. By applying a downward pressure on the pod adaptor 228 and brew basket 224 while they are within the brew chamber 216, the engagement features 282 can pass through slots 248 and be received by the corresponding detents 284, thereby retaining the pod adaptor 228 within the brew chamber 216 in a locked configuration. By locking the pod adaptor 228 and the brew basket 224 relative to the brew chamber 216, the drip-stop valve 236 of the brew basket can also be locked in an open configuration. Additionally, in the locked configuration, the pod adaptor sensor 271b (not shown) can be configured to detect the second indication marker 275 (not shown) and indicate to the controller of the apparatus, that the pod adaptor 228 is being used. In some embodiments, the user interface display 222 can be configured to change based on the indication marker that is detected by the filter adaptor sensor 271a or the pod adaptor sensor 271b. In some embodiments, a brewing operation can be performed with the pod adaptor 228 without using the brew basket 224. Similarly, in this embodiment, the pod adaptor 228 can be placed within the brew chamber 216 with the engagement features 282 aligned with the corresponding detents 184.

In use, a prepackaged pod can be placed within the cavity 272 of the pod adaptor 228, either prior to or after insertion of the pod adaptor 228 and the brew basket 224 into the brew chamber 216. The lid 218 can then be closed and the brewing needle 220 can be configured to puncture a top side of the prepackaged pod. The downward force applied to the top of the pod can push the pod downward within the cavity 272 of the pod adaptor, into the puncturing apparatus 276. It can be advantageous for the pod adaptor 228 to be in a locked configuration relative to the brew chamber 216 so that the brewing needle 220 can reliably puncture that same location on the top of the prepackaged pod as the lid is closed. The user can then activate a brewing process, and fluid can flow out of the brewing needle 220 and into the prepackaged pod to prepare the brewed beverage. Once properly brewed, the brewed beverage can flow out of the puncturing apparatus 276, through the open drip-stop valve 236 into the brew chamber 216, where it can then be delivered to a container configured to receive the brewed beverage.

### Adaptor Storage

As described above, the aforementioned brewing apparatuses 100, 200 each include a filter adaptor 126, 226 and a pod adaptor 128, 228 to be used separately for unique brewing operations, with only one of the filter adaptor 126, 226 or the pod adaptor 128, 228 being used during any given brewing operation. Accordingly, it can be advantageous to provide a storage location for the adaptor that is not being used.

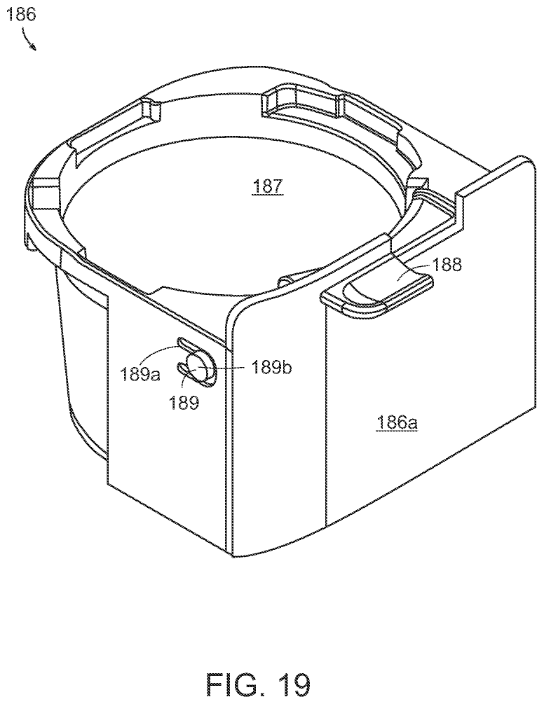

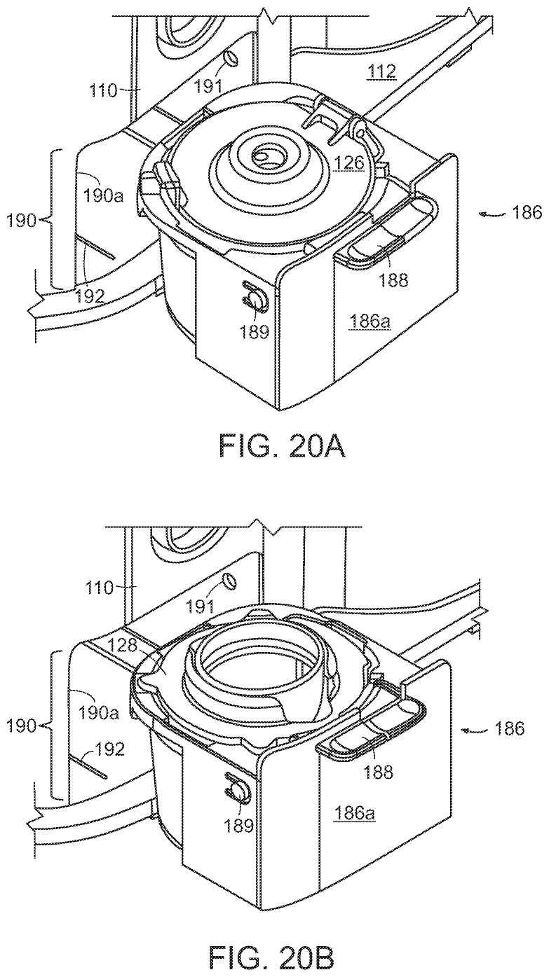

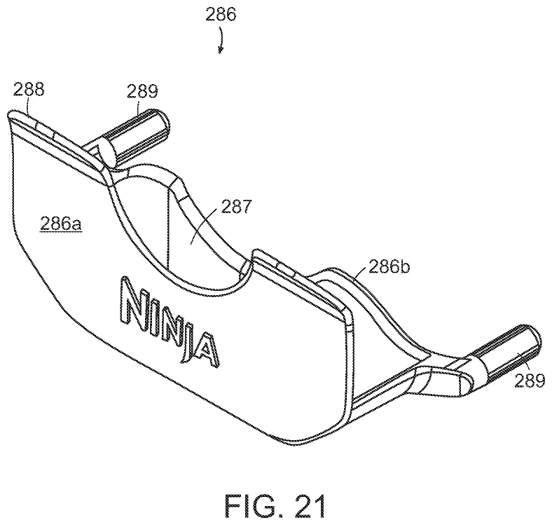

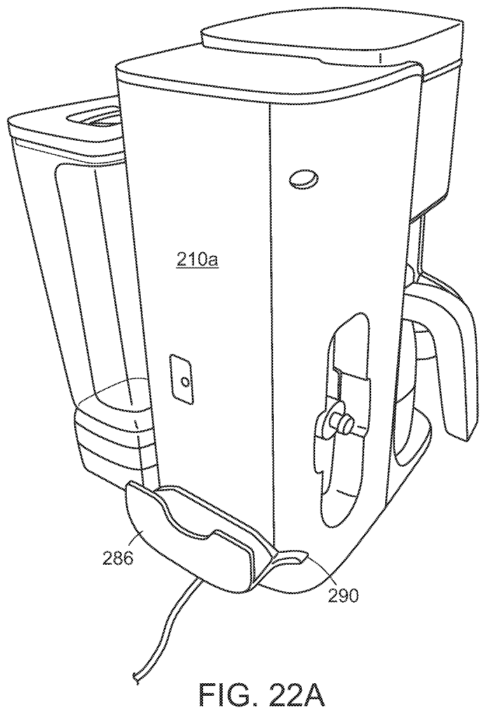

FIG. 19 illustrates one exemplary embodiment of an adaptor storage container 186 for use with the beverage brewing apparatus 100 of FIG. 1A-1B. As shown in FIG. 19, the adaptor storage container 186 includes an outer facing surface 186a and a generally cylindrical cavity 187 configured to separately seat a filter adaptor (i.e., filter adaptor 126 of FIG. 7) and a pod adaptor (i.e., pod adaptor 128 of FIG. 9). The adaptor storage container 186 can further include a handle 188 configured to allow a user to easily place and remove the adaptor storage container 186 within and from a storage opening 190 of the housing 110 of the brewing apparatus 100 (as shown in FIGS. 20-21). In some embodiments, the handle 188 can be configured to fit symmetrically next to the handle 156 of the filter adaptor 126 (as shown in FIG. 7) when the filter adaptor 126 is disposed within the storage container 186. The handle 188 can also be configured to fit symmetrically next to the handle 179 of the pod adaptor 128 (as shown in FIG. 9) when the pod adaptor 128 is disposed within the storage container 186. In some embodiments, the handle 188 can be vertically aligned with the handle 146 of the brew basket 124 (as shown in FIG. 6) when the brew basket 124 is disposed with the brew chamber 116, and the adaptor storage container 186 is disposed within the storage opening 190. The adaptor storage container 186 can further include one or more flexible tabs 189 configured to engage with one or more corresponding storage detents 191 on the interior wall of the storage opening 190 (shown in FIGS. 20-21). In some embodiments, the flexible tabs 189 can include an elastically deformable portion 189a and a button portion 189b protruding from a side of the adaptor storage container 186, the functionality of which will be described in greater detail below. In some embodiments, the flexible tabs 189 can be formed integrally with the adaptor storage container 186 by stamping out one or more C-shaped cuts in a sidewall of the adaptor storage container 186. As shown in FIG. 19, after making a C-shaped cut in a sidewall of the adaptor storage container 186, the deformable portion 189a can be seen as the narrow portion of material left between the arms of the C-shaped cut. Additionally, the button portion 189b can be formed by the center of the C-shaped cut, connected to the rest of the adaptor storage container 186 by the deformable portion 189a.

As seen in both FIG. 20A and FIG. 20B, the storage opening 190 can be configured to receive the adaptor storage container 186 containing either the filter adaptor 126 or pod adaptor 128 therein. The storage opening 190 can include an outer edge 190a. When the adaptor storage container 186 is disposed within storage opening 190 the housing 110, the outer facing surface 186a of the adaptor storage container 186 can be flush with the housing 110, and the edge of the outer facing surface 186a can be configured to make flush contact with the outer edge 190a of the storage opening 190.

The storage opening 190 can further include storage detents 191 configured engage with the flexible tabs 189 when the adaptor storage container 186 is disposed within storage opening 190. In operation, a user can slide the container 186 into the opening 190. When the protruding button portions 189b of the flexible tabs 189 contact the outer edge 190a of the opening 190, the elastically deformable portions 189a of the flexible tabs 189 can be configured deflect inward toward the cavity 187 to allow the button portions 189b to pass into the opening 190. Once the container 186 is fully inserted into the opening, the elastically deformable portions 189a can be configured to deflect back to their original positions as the button portions 189b engage with the storage detents 191 to lock the adaptor storage container 186 within the opening 190.

In some embodiments, the base of the storage opening 190 can be defined by the base 112 of the apparatus 100. In some embodiments, the base of the storage opening 190 can further include guide rails 192 configured to minimize friction as the adaptor storage container 186 is inserted into the opening 190.

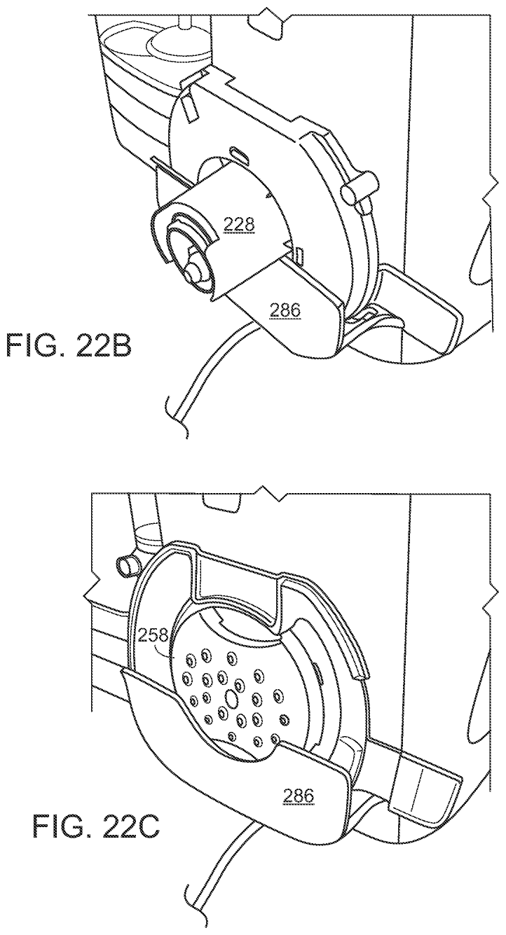

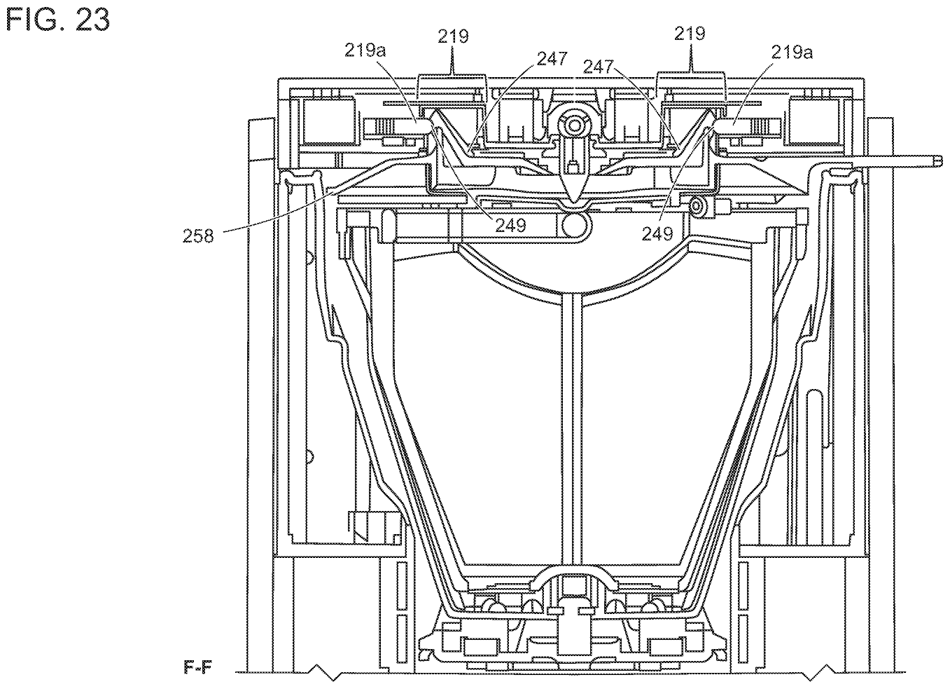

FIG. 21 illustrates another exemplary embodiment of an adaptor storage container 286 for use with the beverage brewing apparatus 200 of FIG. 2A-2B. As shown in FIG. 21, the adaptor storage container 286 includes a cavity 287 configured to separately seat the showerhead 258 for the filter adaptor 226 (as shown in FIG. 14) and the pod adaptor 228 (as shown in FIG. 17). In some embodiments, the cavity 287 of the adaptor storage container 286 can be half-moon shaped, with a C-shaped base, and vertical sidewalls. The adaptor storage container 286 can include at least one handle 288 configured to allow a user to easily connect and disconnect the adaptor storage container 286 from the back of the housing 210 of the brewing apparatus 200, as discussed in greater detail below. In some embodiments, the handle 288 can be formed integrally with an outer facing surface 286a of the adaptor storage container 286, and can be configured to extend from the outer facing surface 286a at a first angle. The adaptor storage container 286 can further include pins 289 configured to engage with corresponding openings 290 (as shown in FIG. 22A) provided in a back 210a of the housing 210 of the beverage apparatus 200, as discussed in greater detail below. In some embodiments, the pins 289 can formed integrally with an inward facing surface 286b of the adaptor storage container 286. As illustrated in FIG. 21, the pins 289 can be cylindrical in shape and can be configured to protrude perpendicularly from the inward facing surface 286b, in a direction away from the cavity 287. In some embodiments, the pins 289 can resemble any other viable prismatic shape.

In use, as illustrated in FIG. 22A, the adaptor storage container 286 can be connected to the back 210a of the housing 210 by inserting the pins 289 into the corresponding openings 290 provided in the back 210a of the housing 210. As illustrated in FIG. 22A, the openings 290 can be cylindrical holes, configured to tightly receive the pins 289. As illustrated in FIGS. 22B and 22C, the cavity 287 of the adaptor storage container 286 can be configured to receive a portion of the pod adaptor 228 and the showerhead 258, respectively, therein. Once placed within the cavity 287, the pod adaptor 228 and the showerhead 258 can be configured to rest within the adaptor storage container 286 in a vertical orientation, parallel to the back 210a of the housing 210.

### Lid Clips

During a brewing operation using a filter adaptor (e.g. filter adaptor 226) it can be advantageous for the showerhead 258 to automatically be lifted off of the filter adaptor 226, but kept within the apparatus 200. Such a feature would eliminate the need for a user to have to manually remove the showerhead 258, while also allowing any excess fluid in the showerhead 258 to drain back into the apparatus, rather than dripping on a countertop, etc. The lid 218 can include cavities 219 which are arranged on either side of the brewing needle 220. The cavities 219 extend inward to the lid 218 for receiving corresponding engagement features from the showerhead 258.

Accordingly, in some embodiments, the top surface 258t of the showerhead 258 can include at least one protrusion portion 247 configured to protrude into a corresponding cavity 219 within the lid 218 (as shown in FIG. 15A). The protrusion portion 247 can further include a detent 249, and the cavity 219 can further include a corresponding engagement feature 219a configured to be received the detent 249 when the lid 218 is closed over the showerhead 258. Each engagement feature 219a is in the form of a spring-loaded projection that is configured to engage a corresponding detent 249 of the showerhead 258. Each detent 249 of the showerhead 258 can be in the form of a small hole extending partially through the sidewall of the protrusion portion 247. A person skilled in the art will appreciate that any number of engagement features can be utilized, and that the projection and detent can be reversed, and further that other engagement features can be used.

FIG. 23 is a cross-sectional view of the brewing apparatus 200 with the lid 218 in the closed configuration, the cross-sectional view shown along section F-F of FIG. 2B. The engagement feature(s) 219a are provided within the cavity 219 such that when the lid 218 is closed over the showerhead 258, the protrusion portions 247 enter the cavities 219 and the engagement feature(s) 219a are received by the detents 249. Once the engagement feature(s) 219a are received by the detents 249, the showerhead 258 can be in a locked configuration relative to the lid 218. Accordingly, when the lid 218 is moved from a closed configuration to an opened configuration, the lid 218 can be configured to lift the showerhead 258 off of the filter adaptor 226, as seen in FIG. 15B.

### Flow Path Covers

As indicated above, during a brewing operation using apparatus 100, 200, a filter adaptor or a pod adaptor can be placed within the brew chamber 116, 216, and the lid 118, 218 can be closed over the brew chamber 116, 216, and a user can initiate a brewing process. In the event that the lid 118, 218 is opened before the brewing process is complete, a flow path between the reservoir 114, 214 and the brewing needle 120, 220 can be disconnected at the upper portion of the flow path and the lower portion of the flow path, as discussed in greater detail below. In this case, the beverage apparatus 100, 200 can be configured to enter a controlled ramp down process, rather than an immediate shutdown, to protect the brewing system equipment. During the ramp down process, however, fluid can continue to flow from the reservoir 114, 214 out of the lower portion of the disconnected flow path, as discussed in greater detail below. Traditionally, this can be hazardous, as the fluid that flows out of the lower portion of the disconnected flow path can be directed toward the user, and in many cases, the flowing fluid can be hot water. Accordingly, it can be advantageous to provide a flow path cover for use in a beverage apparatus, e.g. beverage apparatus 100, 200.

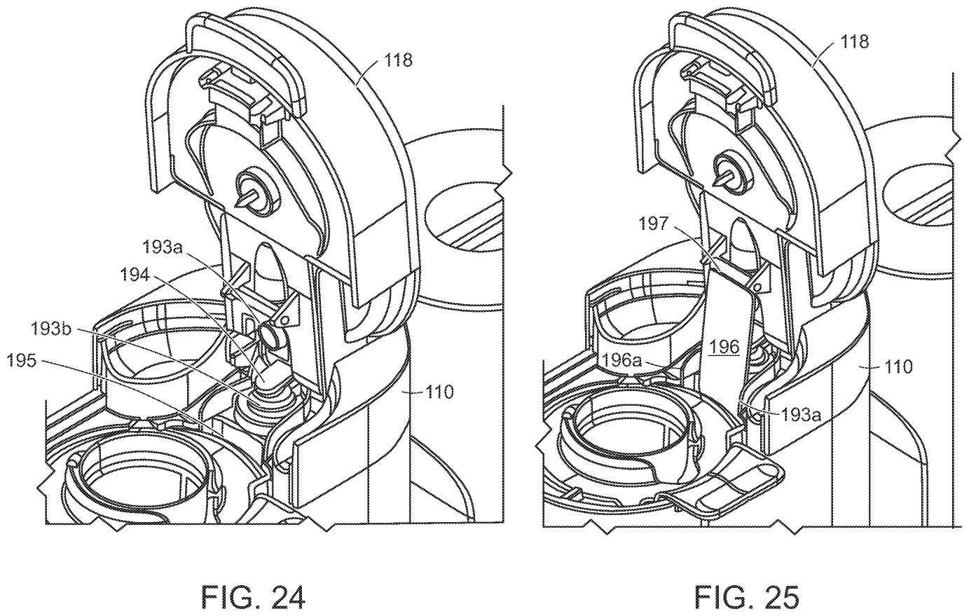

FIG. 24 illustrates an embodiment of a flexible flow path cover 194 for use with the beverage brewing apparatus 100 with a rigid flow path cover 196 removed for clarity. As shown in FIG. 24, the flexible flow path cover 194 can be disposed in between the lid 118 and the housing 110, and configured extend over the lower portion 193b of the flow path 193 (as shown in FIG. 26) when the lid 118 is opened.

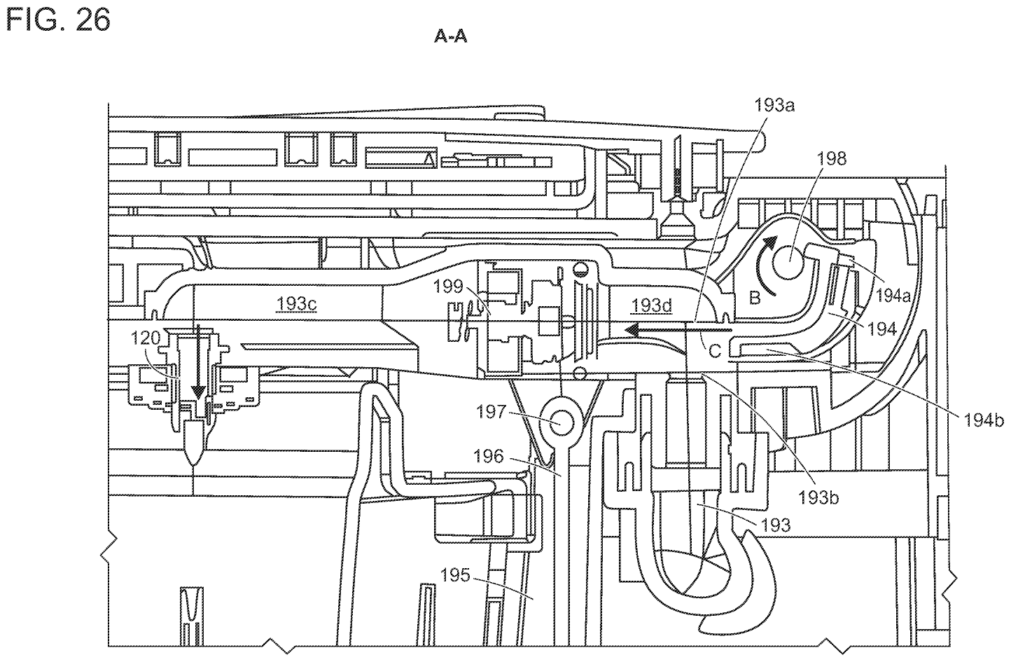

FIG. 25 illustrates an embodiment of a rigid flow path cover 196 for use with the beverage brewing apparatus 100. As shown in FIG. 25, the rigid flow path cover 196 can be coupled to the lid 118 at hinge 197, and configured extend over the upper portion 193a and the lower portion 193b of the flow path 193 (as shown in FIG. 26) and the flexible flow path cover 194 when the lid 118 is opened.

FIG. 26 is a cross-sectional view of the brewing apparatus of FIG. 1B taken along section A-A. As illustrated in FIG. 26. With the lid 118 is in the closed configuration, the upper and lower portions 193a, 193b of the flow path 193, respectively, can be connected to allow fluid to flow from the reservoir 114 to the brewing needle 120. As illustrated in FIG. 26, the flexible flow path cover 194 can include a connection end 194a configured to couple the flexible flow path cover 194 to the beverage brewing apparatus 100. The flexible flow path cover 194 can also include a covering end 194b configured to cover the lower portion 193b of the flow path 193 when the lid 118 is in the open configuration. The lid can be configured to open and close by pivoting around hinge 198. When the lid 118 is opened, the lid 118 can be configured to rotate the hinge 198 in the direction B, causing the retracted flexible flow path cover 194 to extend in direction C to cover the lower portion 193b of the flow path 193 as the upper portion 193a disconnects therefrom. In some embodiments, the flexible flow path cover 194 can be made from rubber, or any other viable flexible, heat resistant material. Additionally, when the lid 118 is in the closed configuration, the rigid flow path cover 196 can be configured to nest in a vertical position within cavity 195. When the lid 118 is opened, the lid 118 can be configured to rotate the hinge 198 in the direction B, causing the retracted rigid flow path cover 196 to lift out of the cavity 195 to cover the upper portion 193a and the lower portion 193b of the flow path 193, and the flexible flow path cover 194.

During a brewing operation, fluid can be configured to flow from the reservoir 114 to the brewing needle 120 as discussed above, through the connected upper portion 193a and lower portion 193b of the flow path 193. In the event that the lid 118 is opened, during the ramp down process, fluid can continue to flow from the reservoir 114 out of the lower portion 193b of the disconnected flow path 193. In order to prevent the fluid flowing out of the lower portion 193b from being directed at the user, the retracted flexible flow path cover 194 can be configured to rotate about hinge 198 in direction B, and extend in direction C to cover the lower portion 193b of the flow path 193 as the upper portion 193a disconnects therefrom. Fluid in a portion 193c of the flow path 193 can be prevented from flowing back into a portion 193d of the flow path 193 by a check valve 199. In some embodiments, the check valve 199 can also be configured to mitigate any back pressure in the system that may cause loose coffee grounds to be pulled up through the needle 120 into the portion 193c and potentially causing a needle blockage. However, in the event that the lid 118 is opened, fluid in portion 193d can flow back toward the disconnected upper portion 193a. In order to prevent the fluid flowing out of the upper portion 193a from being directed at the user, the retracted rigid flow path cover 196 can be configured to lift out of the cavity 195 to cover the upper portion 193a and direct the fluid down into the cavity 195 and into the brew chamber 116 (not shown).

In this embodiment, the beverage apparatus can further include a fluid run-off channels 196a configured to direct fluid from the flow path 193, over the brew chamber 116 and into the brew basket 124. In some embodiments, the fluid run-off channel 196a can be made from rubber, or any other viable heat resistant material, or integral with the housing 110.

In another embodiment, referring back to FIG. 2A, a flow path cover 294, for use in beverage apparatus 200 is provided. In this embodiment, as illustrated in FIG. 16, the flow path 293 between the reservoir 214 and the brewing needle 220 can remain connected in the event that the lid 218 is opened. As shown in FIG. 16, a flow path cover 294 can include a covering portion 294a and a coupling portion 294b. The flow path cover 294 can be coupled to the lid 218 at coupling portion 294b. Further, when the lid 218 is in the closed configuration, the covering portion 294a of the flow path cover 294 can be configured to be clamped in between the lid 218 and the housing 210, creating a seal to prevent fluid from flowing out of portion 293a of the flow path 293. By preventing the flow of fluid out of the portion 293a of the flow path 293, all of the fluid flowing from the reservoir 214 (as discussed above as shown in FIG. 3) can be configured to flow into a portion 293b of the flow path 293, through a check valve 298 and into a portion 293c of the flow path 293 to the brewing needle 220. In some embodiments, the flow path cover 294 can be made from rubber, or any other viable, heat resistant material.

In this embodiment, the beverage apparatus can further include a fluid run-off channel 296 configured to direct fluid from the portion 293a of the flow path 293, over the brew chamber 216 and into the brew basket 224. In some embodiments, the fluid run-off channel 296 can be made from rubber, or any other viable, heat resistant material, or can be integral with the housing 210.

In the event that the lid 218 is opened, the clamped seal formed between lid 218 and the housing 210 by the flow path cover 294 can be broken as the flow path cover 294 moves with the lid 218 into a vertical position. In this case, fluid in a region 293c of the flow path 293 can be prevented from flowing back into a portion 293b of the flow path 293 by the check valve 298. In some embodiments, the check valve 299 can also be configured to mitigate any back pressure in the system that may cause loose coffee grounds to be pulled up through the needle 220 into the portion 293c and potentially causing a needle blockage. However, during the ramp down process, fluid can remain in portion 293b and can continue to flow from the reservoir 214 into the portion 293b of the flow path 293. This can lead to a buildup of fluid in portions 293a and 293b of the flow path 293. In order to prevent the fluid built up in portions 293a and 293b from being directed at the user, the fluid can be configured to flow out of the portion 294a and come into contact with the covering portion 294a of the flow path cover 294. The fluid that contacts the covering portion 294a can be directed downward toward the housing and can be then be configured to flow across the fluid run-off channel 296, over the brew chamber 216 and into the brew basket 224.

Certain exemplary implementations have been described to provide an overall understanding of the principles of the structure, function, manufacture, and use of the systems, devices, and methods disclosed herein. One or more examples of these implementations have been illustrated in the accompanying drawings. Those skilled in the art will understand that the systems, devices, and methods specifically described herein and illustrated in the accompanying drawings are non-limiting exemplary implementations and that the scope of the present invention is defined solely by the claims. The features illustrated or described in connection with one exemplary implementation may be combined with the features of other implementations. Such modifications and variations are intended to be included within the scope of the present invention. Further, in the present disclosure, like-named components of the implementations generally have similar features, and thus within a particular implementation each feature of each like-named component is not necessarily fully elaborated upon.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

One skilled in the art will appreciate further features and advantages of the invention based on the above-described implementations. Accordingly, the present application is not to be limited by what has been particularly shown and described, except as indicated by the appended claims. All publications and references cited herein are expressly incorporated by reference in their entirety.

What is claimed is:

1. A beverage system, comprising:
a housing having a brew chamber defining a cavity therein;
an opening arranged in the housing and configured to allow access to the brew chamber;
a lid configured to selectively cover the opening of the brew chamber, the lid having at least one engagement feature; and
a filter assembly selectively receivable within the cavity of the brew chamber, the filter assembly comprising:
a lower portion defining a cavity therein configured to receive a brewing ingredient; and
an upper portion arranged over the cavity of the lower portion, the upper portion including at least one corresponding engagement feature configured to receive the at least one engagement feature of the lid therein.

2. The beverage system of claim 1, wherein the lid includes a first engagement feature and a second engagement feature arranged opposite each other.

3. The beverage system of claim 1, wherein the upper portion includes a first corresponding engagement feature and a second corresponding engagement feature arranged opposite each other.

4. The beverage system of claim 1, wherein the at least one engagement feature of the lid comprises a spring-loaded projection, and the at least one corresponding engagement feature of the filter assembly comprises at least one detent.

5. The beverage system of claim 1, wherein the first portion of the filter assembly is a brew basket configured to allow fluid flow therethrough, and the second portion is a shower head, the shower head being configured to receive fluid through an opening therein and to distribute fluid into the brew basket.

6. The beverage system of claim 1, wherein the detent is positioned on raised projection extending upward from a top surface of the upper portion.

7. The beverage system of claim 1, wherein the upper portion is configured to be secured to the lid such that the upper portion is removed from the lower portion when the lid transitions from a closed position to an open position.

8. The beverage system of claim 1, wherein the lid includes a projection including a fluid outlet therein.

9. The beverage system of claim 8, wherein the projection is positioned between a first corresponding engagement feature and a second corresponding engagement feature arranged opposite each other.

10. The beverage system of claim 1, wherein the upper portion of the filter assembly includes an indication marker configured to indicate a position of the upper portion within the brew chamber.

11. The beverage system of claim 1, wherein the at least one engagement feature is arranged within a recessed cavity of the lid.

12. A filter assembly for use in a beverage system, comprising:
a brew basket defining a cavity therein and having a fluid outlet;
a shower head configured to be positioned over the cavity of the brew basket, the shower head being configured to receive fluid through an opening therein and to distribute fluid into the brew basket;
at least one projection extending upward from a top surface of the shower head; and
at least one engagement feature positioned on the at least one projection.

13. The filter assembly of claim 12, wherein the brew basket includes a first handle extending radially outward from the brew basket.

14. The filter assembly of claim 13, wherein the shower head includes a second handle configured to be positioned adjacent to the first handle when the showerhead is positioned above the cavity of the brew basket.

15. The filter assembly of claim 12, wherein the shower head includes a first engagement feature and a second engagement feature arranged opposite each other.

16. The filter assembly of claim 12, wherein the shower head includes an indication marker configured to indicate a position of the shower head within the brew basket.

17. A beverage system, comprising:
a housing having a brew chamber defining a cavity therein;
an opening arranged in the housing and configured to allow access to the brew chamber;
a lid configured to selectively cover the opening of the brew chamber, the lid having a recessed cavity and at least one engagement feature positioned therein; and
a filter assembly selectively receivable within the cavity of the brew chamber, the filter assembly comprising:
a brew basket defining a cavity therein and having a fluid outlet;
a shower head configured to be positioned over the cavity of the brew basket, the shower head being configured to receive fluid through an opening therein and to distribute fluid into the brew basket;
at least one projection extending upward from a top surface of the shower head; and
at least one corresponding engagement feature positioned on the at least one projection.

18. The beverage system of claim 17, wherein the lid includes a first engagement feature and a second engagement feature arranged opposite each other.

19. The beverage system of claim 17, wherein the shower head includes a first corresponding engagement feature and a second corresponding engagement feature arranged opposite each other.

20. The beverage of claim 17, wherein the at least one engagement feature of the lid comprises a spring-loaded projection, and the at least one corresponding engagement feature of the filter assembly comprises at least one detent
